(19) United States
(12) Patent Application Publication
(10) Pub. No.: US 2018/0359495 A1
(43) Pub. Date: Dec. 13, 2018

(54) APPARATUS FOR BROADCAST SIGNAL TRANSMISSION, APPARATUS FOR BROADCAST SIGNAL RECEPTION, METHOD FOR BROADCAST SIGNAL TRANSMISSION, AND METHOD FOR BROADCAST SIGNAL RECEPTION

(71) Applicant: LG ELECTRONICS INC., Seoul (KR)

(72) Inventors: Hyunmook OH, Seoul (KR); Jongyeul SUH, Seoul (KR)

(73) Assignee: LG ELECTRONICS INC., Seoul (KR)

(21) Appl. No.: 15/575,661

(22) PCT Filed: Jun. 23, 2016
(86) PCT No.: PCT/KR2016/006691

§ 371 Date: Nov. 20, 2017

Related U.S. Application Data
(60) Provisional application No. 62/183,724, filed on Jun. 23, 2015.

(51) Int. Cl. H04N 21/235; H04N 21/2362; H04N 21/434

(52) U.S. Cl. CPC H04N 21/2353; H04N 21/2358; H04H 60/82; H04N 21/4348; H04N 21/2362

(57) ABSTRACT

The present invention suggests a method for transmitting a broadcast signal. The method for transmitting a broadcast signal according to the present invention, suggests a system for supporting a next-generation broadcast service in an environment for supporting a next-generation hybrid broadcast using a ground wave broadcasting network and an internet network, and an efficient signaling plan which can embrace the entire ground wave broadcasting network and the internet network in the environment for supporting the next-generation hybrid broadcast.

### TECHNICAL FIELD

The present invention relates to a broadcast signal transmission apparatus, a broadcast signal reception apparatus, and broadcast signal transmission/reception methods.

### BACKGROUND ART

As analog broadcasting comes to an end, various technologies for transmitting/receiving digital broadcast signals are being developed. A digital broadcast signal may include a larger amount of video/audio data than an analog broadcast signal and further include various types of supplementary data in addition to the video/audio data.

UHD broadcast aims at provision of better picture quality and immersiveness than HD broadcast to viewers through various aspects. To this end, a method of extending a dynamic range and a color gamut represented in content to a dynamic range and a color gamut which can be visually recognized by users, that is, HDR (high dynamic range) and WCG (wide color gamut), is expected to be introduced. That is, content provides enhanced contrast and color such that users who view UHD content can experience enhanced immersiveness and sense of realism. The present invention suggests a method capable of effectively reproducing brightness and colors of images according to intention of a producer when content is displayed through a display such that users can view images with enhanced picture quality.

### DISCLOSURE

### Technical Problem

That is, a digital broadcast system can provide HD (high definition) images, multichannel audio and various additional services. However, data transmission efficiency for transmission of large amounts of data, robustness of transmission/reception networks and network flexibility in consideration of mobile reception equipment need to be improved for digital broadcast.

### Technical Solution

The present invention proposes a system capable of effectively supporting next-generation broadcast services in an environment supporting next-generation hybrid broadcasting using terrestrial broadcast networks and the Internet and related signaling methods as included and approximately described herein according to objects of the present invention.

### Advantageous Effects

The present invention provides a method for viewing HDR content as intended when the HDR content is produced.

The present invention provides a new EOTF which can be used when HDR content is encoded.

The present invention provides a method of signaling information about an EOTF used when HDR content is encoded.

### DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a diagram illustrating a protocol stack according to one embodiment of the present invention;

FIG. 2 is a diagram illustrating a service discovery procedure according to one embodiment of the present invention;

FIG. 3 is a diagram showing a low level signaling (LLS) table and a service list table (SLT) according to one embodiment of the present invention;

FIG. 4 is a diagram showing a USBD and an S-TSID delivered through ROUTE according to one embodiment of the present invention;

FIG. 5 is a diagram showing a USBD delivered through MMT according to one embodiment of the present invention;

FIG. 6 is a diagram showing link layer operation according to one embodiment of the present invention;

FIG. 7 is a diagram showing a link mapping table (LMT) according to one embodiment of the present invention;

FIG. 8 is a diagram illustrating a structure of a transceiving system for adaptive EOTF based HDR broadcast services according to an embodiment of the present invention;

FIG. 9 is a diagram illustrating a structure of a receiver according to an embodiment of the present invention;

FIG. 10 is a diagram illustrating an operation performed by a second post-processing unit according to an embodiment of the present invention;

FIG. 11 is a diagram illustrating a configuration of an EOTF_parameter_info SEI (supplemental enhancement information) message according to an embodiment of the present invention;

FIG. 12 is a diagram illustrating description of EOTF_curve_type field values according to an embodiment of the present invention;

FIG. 13 is a diagram illustrating functional formulas according to EOTF_curve_type field values according to an embodiment of the present invention;

FIG. 14 is a diagram describing a case in which EOTF parameter information is signaled through a program map table (PMT) according to an embodiment of the present invention;

FIG. 15 is a diagram describing a case in which EOTF parameter information is signaled through an event information table (EIT) according to an embodiment of the present invention;

FIG. 16 is a diagram illustrating a configuration of an EOTF_parameter_info_descriptor according to an embodiment of the present invention;

FIG. 17 is a diagram illustrating a structure of a receiver according to an embodiment of the present invention;

FIG. 18 is a diagram illustrating a method of transmitting a broadcast signal according to an embodiment of the present invention;

FIG. 19 is a diagram illustrating a method of receiving a broadcast signal according to an embodiment of the present invention; and

FIG. 20 is a diagram illustrating a configuration of an apparatus for transmitting a broadcast signal according to an embodiment of the present invention.

### BEST MODE

The present invention provides apparatuses and methods for transmitting and receiving broadcast signals for future broadcast services. Future broadcast services according to an embodiment of the present invention include a terrestrial broadcast service, a mobile broadcast service, an ultra high definition television (UHDTV) service, etc. The present invention may process broadcast signals for the future broadcast services through non-MIMO (Multiple Input Multiple Output) or MIMO according to one embodiment. A non-MIMO scheme according to an embodiment of the present invention may include a MISO (Multiple Input Single Output) scheme, a SISO (Single Input Single Output) scheme, etc. The present invention proposes a physical profile (or system) optimized to minimize receiver complexity while accomplishing performance required for a specific purpose.

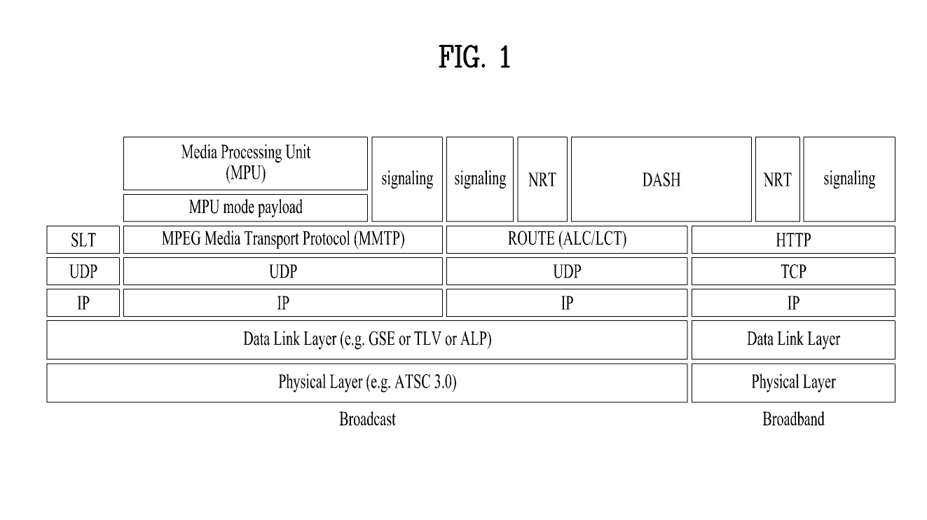

FIG. 1 is a diagram showing a protocol stack according to an embodiment of the present invention.

A service may be delivered to a receiver through a plurality of layers. First, a transmission side may generate service data. The service data may be processed for transmission at a delivery layer of the transmission side and the service data may be encoded into a broadcast signal and transmitted over a broadcast or broadband network at a physical layer.

Here, the service data may be generated in an ISO base media file format (BMFF). ISO BMFF media files may be used for broadcast/broadband network delivery, media encapsulation and/or synchronization format. Here, the service data is all data related to the service and may include service components configuring a linear service, signaling information thereof, non-real time (NRT) data and other files.

The delivery layer will be described. The delivery layer may provide a function for transmitting service data. The service data may be delivered over a broadcast and/or broadband network.

Broadcast service delivery may include two methods.

As a first method, service data may be processed in media processing units (MPUs) based on MPEG media transport (MMT) and transmitted using an MMT protocol (MMTP). In this case, the service data delivered using the MMTP may include service components for a linear service and/or service signaling information thereof.

As a second method, service data may be processed into DASH segments and transmitted using real time object delivery over unidirectional transport (ROUTE), based on MPEG DASH. In this case, the service data delivered through the ROUTE protocol may include service components for a linear service, service signaling information thereof and/or NRT data. That is, the NRT data and non-timed data such as files may be delivered through ROUTE.

Data processed according to MMTP or ROUTE protocol may be processed into IP packets through a UDP/IP layer. In service data delivery over the broadcast network, a service list table (SLT) may also be delivered over the broadcast network through a UDP/IP layer. The SLT may be delivered in a low level signaling (LLS) table. The SLT and LLS table will be described later.

IP packets may be processed into link layer packets in a link layer. The link layer may encapsulate various formats of data delivered from a higher layer into link layer packets and then deliver the packets to a physical layer. The link layer will be described later.

In hybrid service delivery, at least one service element may be delivered through a broadband path. In hybrid service delivery, data delivered over broadband may include service components of a DASH format, service signaling information thereof and/or NRT data. This data may be processed through HTTP/TCP/IP and delivered to a physical layer for broadband transmission through a link layer for broadband transmission.

The physical layer may process the data received from the delivery layer (higher layer and/or link layer) and transmit the data over the broadcast or broadband network. A detailed description of the physical layer will be given later.

The service will be described. The service may be a collection of service components displayed to a user, the components may be of various media types, the service may be continuous or intermittent, the service may be real time or non-real time, and a real-time service may include a sequence of TV programs.

The service may have various types. First, the service may be a linear audio/video or audio service having app based enhancement. Second, the service may be an app based service, reproduction/configuration of which is controlled by a downloaded application. Third, the service may be an ESG service for providing an electronic service guide (ESG). Fourth, the service may be an emergency alert (EA) service for providing emergency alert information.

When a linear service without app based enhancement is delivered over the broadcast network, the service component may be delivered by (1) one or more ROUTE sessions or (2) one or more MMTP sessions.

When a linear service having app based enhancement is delivered over the broadcast network, the service component may be delivered by (1) one or more ROUTE sessions or (2) zero or more MMTP sessions. In this case, data used for app based enhancement may be delivered through a ROUTE session in the form of NRT data or other files. In one embodiment of the present invention, simultaneous delivery of linear service components (streaming media components) of one service using two protocols may not be allowed.

When an app based service is delivered over the broadcast network, the service component may be delivered by one or more ROUTE sessions. In this case, the service data used for the app based service may be delivered through the ROUTE session in the form of NRT data or other files.

Some service components of such a service, some NRT data, files, etc. may be delivered through broadband (hybrid service delivery).

That is, in one embodiment of the present invention, linear service components of one service may be delivered through the MMT protocol. In another embodiment of the present invention, the linear service components of one service may be delivered through the ROUTE protocol. In another embodiment of the present invention, the linear service components of one service and NRT data (NRT service components) may be delivered through the ROUTE protocol. In another embodiment of the present invention, the linear service components of one service may be delivered through the MMT protocol and the NRT data (NRT service components) may be delivered through the ROUTE protocol. In the above-described embodiments, some service components of the service or some NRT data may be delivered through broadband. Here, the app based service and data regarding app based enhancement may be delivered over the broadcast network according to ROUTE or through broadband in the form of NRT data. NRT data may be referred to as locally cached data.

Each ROUTE session includes one or more LCT sessions for wholly or partially delivering content components configuring the service. In streaming service delivery, the LCT session may deliver individual components of a user service, such as audio, video or closed caption stream. The streaming media is formatted into a DASH segment.

Each MMTP session includes one or more MMTP packet flows for delivering all or some of content components or an MMT signaling message. The MMTP packet flow may deliver a component formatted into MPU or an MMT signaling message.

For delivery of an NRT user service or system metadata, the LCT session delivers a file based content item. Such content files may include consecutive (timed) or discrete (non-timed) media components of the NRT service or metadata such as service signaling or ESG fragments. System metadata such as service signaling or ESG fragments may be delivered through the signaling message mode of the MMTP.

A receiver may detect a broadcast signal while a tuner tunes to frequencies. The receiver may extract and send an SLT to a processing module. The SLT parser may parse the SLT and acquire and store data in a channel map. The receiver may acquire and deliver bootstrap information of the SLT to a ROUTE or MMT client. The receiver may acquire and store an SLS. USBD may be acquired and parsed by a signaling parser.

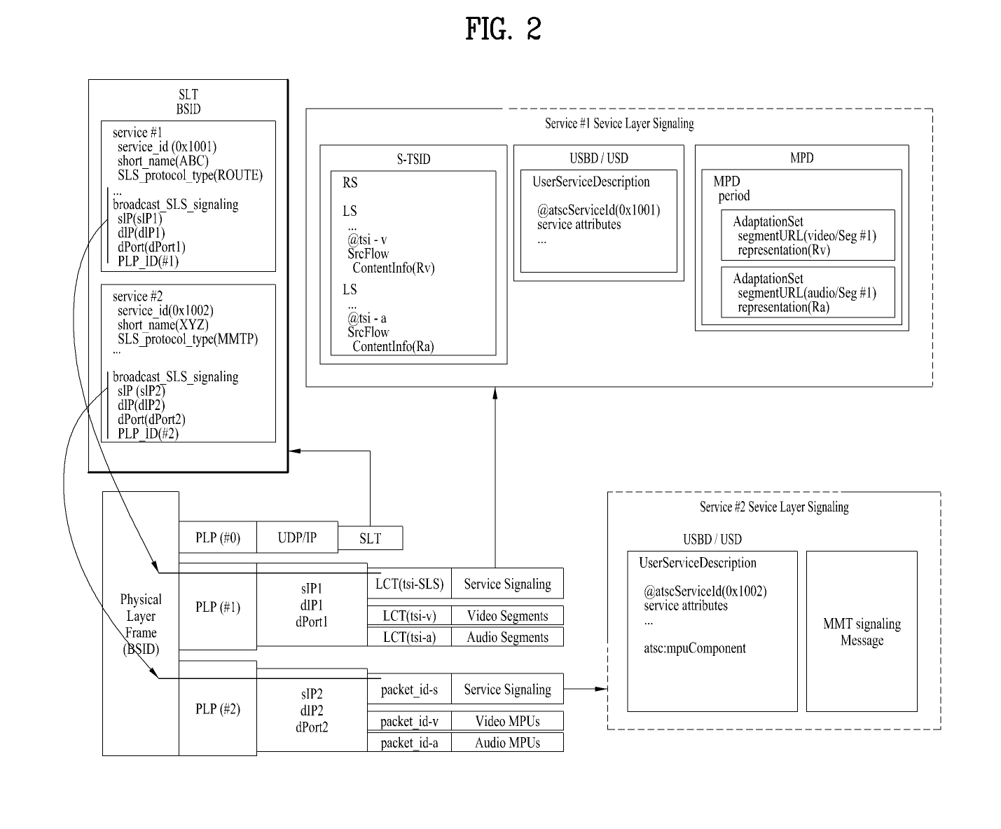

FIG. 2 is a diagram showing a service discovery procedure according to one embodiment of the present invention.

A broadcast stream delivered by a broadcast signal frame of a physical layer may carry low level signaling (LLS). LLS data may be carried through payload of IP packets delivered to a well-known IP address/port. This LLS may include an SLT according to type thereof. The LLS data may be formatted in the form of an LLS table. A first byte of every UDP/IP packet carrying the LLS data may be the start of the LLS table. Unlike the shown embodiment, an IP stream for delivering the LLS data may be delivered to a PLP along with other service data.

The SLT may enable the receiver to generate a service list through fast channel scan and provides access information for locating the SLS. The SLT includes bootstrap information. This bootstrap information may enable the receiver to acquire service layer signaling (SLS) of each service. When the SLS, that is, service signaling information, is delivered through ROUTE, the bootstrap information may include an LCT channel carrying the SLS, a destination IP address of a ROUTE session including the LCT channel and destination port information. When the SLS is delivered through the MMT, the bootstrap information may include a destination IP address of an MMTP session carrying the SLS and destination port information.

In the shown embodiment, the SLS of service #1 described in the SLT is delivered through ROUTE and the SLT may include bootstrap information sIP1, dIP1 and dPort1 of the ROUTE session including the LCT channel delivered by the SLS. The SLS of service #2 described in the SLT is delivered through MMT and the SLT may include bootstrap information sIP2, dIP2 and dPort2 of the MMTP session including the MMTP packet flow delivered by the SLS.

The SLS is signaling information describing the properties of the service and may include receiver capability information for significantly reproducing the service or providing information for acquiring the service and the service component of the service. When each service has separate service signaling, the receiver acquires appropriate SLS for a desired service without parsing all SLSs delivered within a broadcast stream.

When the SLS is delivered through the ROUTE protocol, the SLS may be delivered through a dedicated LCT channel of a ROUTE session indicated by the SLT. In some embodiments, this LCT channel may be an LCT channel identified by tsi=0. In this case, the SLS may include a user service bundle description (USBD)/user service description (USD), service-based transport session instance description (S-TSID) and/or media presentation description (MPD).

Here, USBD/USD is one of SLS fragments and may serve as a signaling hub describing detailed description information of a service. The USBD may include service identification information, device capability information, etc. The USBD may include reference information (URI reference) of other SLS fragments (S-TSID, MPD, etc.). That is, the USBD/USD may reference the S-TSID and the MPD. In addition, the USBD may further include metadata information for enabling the receiver to decide a transmission mode (broadcast/broadband network). A detailed description of the USBD/USD will be given below.

The S-TSID is one of SLS fragments and may provide overall session description information of a transport session carrying the service component of the service. The S-TSID may provide the ROUTE session through which the service component of the service is delivered and/or transport session description information for the LCT channel of the ROUTE session. The S-TSID may provide component acquisition information of service components associated with one service. The S-TSID may provide mapping between DASH representation of the MPD and the tsi of the service component. The component acquisition information of the S-TSID may be provided in the form of the identifier of the associated DASH representation and tsi and may or may not include a PLP ID in some embodiments. Through the component acquisition information, the receiver may collect audio/video components of one service and perform buffering and decoding of DASH media segments. The S-TSID may be referenced by the USBD as described above. A detailed description of the S-TSID will be given below.

The MPD is one of SLS fragments and may provide a description of DASH media presentation of the service. The MPD may provide a resource identifier of media segments and provide context information within the media presentation of the identified resources. The MPD may describe DASH representation (service component) delivered over the broadcast network and describe additional DASH presentation delivered over broadband (hybrid delivery). The MPD may be referenced by the USBD as described above.

When the SLS is delivered through the MMT protocol, the SLS may be delivered through a dedicated MMTP packet flow of the MMTP session indicated by the SLT. In some embodiments, the packet_id of the MMTP packets delivering the SLS may have a value of 00. In this case, the SLS may include a USBD/USD and/or MMT packet (MP) table.

Here, the USBD is one of SLS fragments and may describe detailed description information of a service as in ROUTE. This USBD may include reference information (URI information) of other SLS fragments. The USBD of the MMT may reference an MP table of MMT signaling. In some embodiments, the USBD of the MMT may include reference information of the S-TSID and/or the MPD. Here, the S-TSID is for NRT data delivered through the ROUTE protocol. Even when a linear service component is delivered through the MMT protocol, NRT data may be delivered via the ROUTE protocol. The MPD is for a service component delivered over broadband in hybrid service delivery. The detailed description of the USBD of the MMT will be given below.

The MP table is a signaling message of the MMT for MPU components and may provide overall session description information of an MMTP session carrying the service component of the service. In addition, the MP table may include a description of an asset delivered through the MMTP session. The MP table is streaming signaling information for MPU components and may provide a list of assets corresponding to one service and location information (component acquisition information) of these components. The detailed description of the MP table may be defined in the MMT or modified. Here, the asset is a multimedia data entity, is combined by one unique ID, and may mean a data entity used to one multimedia presentation. The asset may correspond to service components configuring one service. A streaming service component (MPU) corresponding to a desired service may be accessed using the MP table. The MP table may be referenced by the USBD as described above.

The other MMT signaling messages may be defined. Additional information associated with the service and the MMTP session may be described by such MMT signaling messages.

The ROUTE session is identified by a source IP address, a destination IP address and a destination port number. The LCT session is identified by a unique transport session identifier (TSI) within the range of a parent ROUTE session. The MMTP session is identified by a destination IP address and a destination port number. The MMTP packet flow is identified by a unique packet_id within the range of a parent MMTP session.

In case of ROUTE, the S-TSID, the USBD/USD, the MPD or the LCT session delivering the same may be referred to as a service signaling channel In case of MMTP, the USBD/UD, the MMT signaling message or the packet flow delivering the same may be referred to as a service signaling channel.

Unlike the shown embodiment, one ROUTE or MMTP session may be delivered over a plurality of PLPs. That is, one service may be delivered through one or more PLPs. Unlike the shown embodiment, in some embodiments, components configuring one service may be delivered through different ROUTE sessions. In addition, in some embodiments, components configuring one service may be delivered through different MMTP sessions. In some embodiments, components configuring one service may be divided and delivered in a ROUTE session and an MMTP session. Although not shown, components configuring one service may be delivered through broadband (hybrid delivery).

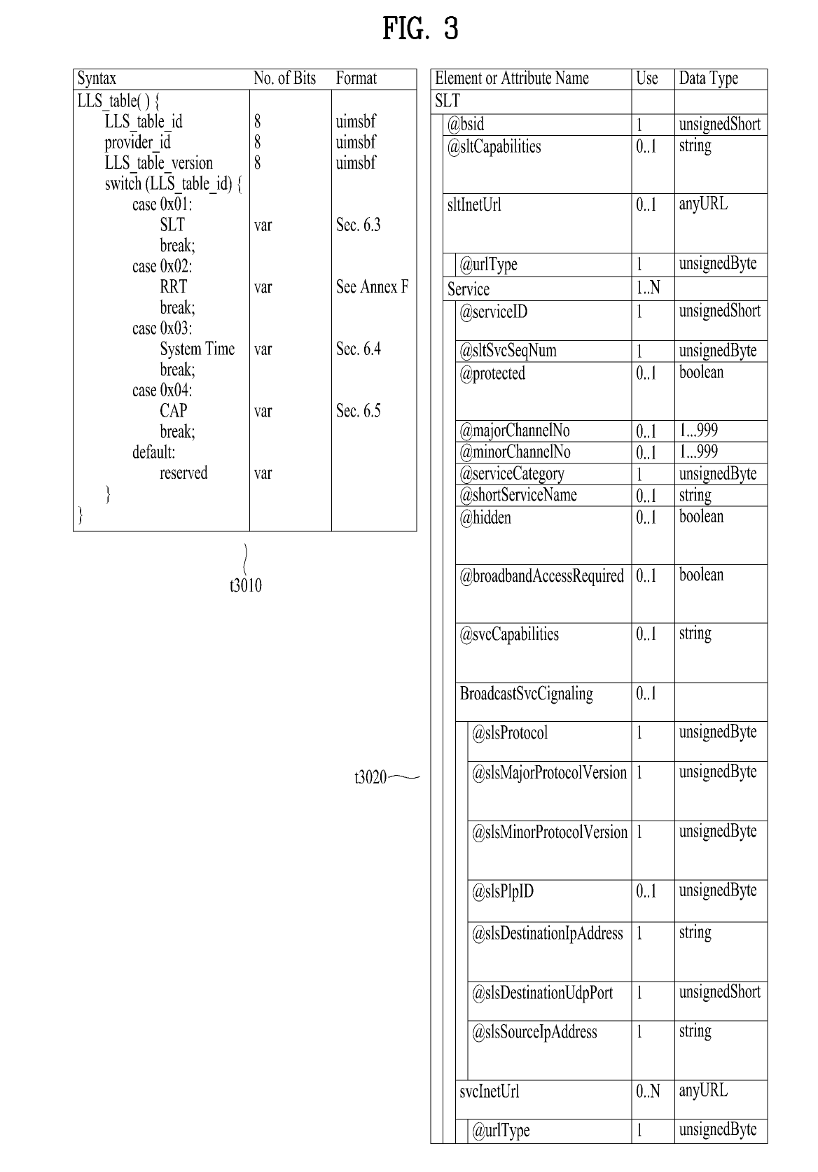

FIG. 3 is a diagram showing a low level signaling (LLS) table and a service list table (SLT) according to one embodiment of the present invention.

One embodiment t3010 of the LLS table may include information according to an LLS_table_id field, a provider_id field, an LLS_table_version field and/or an LLS_table_id field.

The LLS_table_id field may identify the type of the LLS table, and the provider_id field may identify a service provider associated with services signaled by the LLS table. Here, the service provider is a broadcaster using all or some of the broadcast streams and the provider_id field may identify one of a plurality of broadcasters which is using the broadcast streams. The LLS_table_version field may provide the version information of the LLS table.

According to the value of the LLS_table_id field, the LLS table may include one of the above-described SLT, a rating region table (RRT) including information on a content advisory rating, SystemTime information for providing information associated with a system time, a common alert protocol (CAP) message for providing information associated with emergency alert. In some embodiments, the other information may be included in the LLS table.

One embodiment t3020 of the shown SLT may include an @bsid attribute, an @sltCapabilities attribute, an sltInetUrl element and/or a Service element. Each field may be omitted according to the value of the shown Use column or a plurality of fields may be present.

The @bsid attribute may be the identifier of a broadcast stream. The @sltCapabilities attribute may provide capability information required to decode and significantly reproduce all services described in the SLT. The sltInetUrl element may provide base URL information used to obtain service signaling information and ESG for the services of the SLT over broadband. The sltInetUrl element may further include an @urlType attribute, which may indicate the type of data capable of being obtained through the URL.

The Service element may include information on services described in the SLT, and the Service element of each service may be present. The Service element may include an @serviceId attribute, an @sltSvcSeqNum attribute, an @protected attribute, an @majorChannelNo attribute, an @minorChannelNo attribute, an @serviceCategory attribute, an @shortServiceName attribute, an @hidden attribute, an @broadbandAccessRequired attribute, an @svcCapabilities attribute, a BroadcastSvcSignaling element and/or an svcInetUrl element.

The @serviceId attribute is the identifier of the service and the @sltSvcSeqNum attribute may indicate the sequence number of the SLT information of the service. The @protected attribute may indicate whether at least one service component necessary for significant reproduction of the service is protected. The @majorChannelNo attribute and the @minorChannelNo attribute may indicate the major channel number and minor channel number of the service, respectively.

The @serviceCategory attribute may indicate the category of the service. The category of the service may include a linear A/V service, a linear audio service, an app based service, an ESG service, an EAS service, etc. The @shortServiceName attribute may provide the short name of the service. The @hidden attribute may indicate whether the service is for testing or proprietary use. The @broadbandAccessRequired attribute may indicate whether broadband access is necessary for significant reproduction of the service. The @svcCapabilities attribute may provide capability information necessary for decoding and significant reproduction of the service.

The BroadcastSvcSignaling element may provide information associated with broadcast signaling of the service. This element may provide information such as location, protocol and address with respect to signaling over the broadcast network of the service. Details thereof will be described below.

The svcInetUrl element may provide URL information for accessing the signaling information of the service over broadband. The sltInetUrl element may further include an @urlType attribute, which may indicate the type of data capable of being obtained through the URL.

The above-described BroadcastSvcSignaling element may include an @slsProtocol attribute, an @slsMajorProtocolVersion attribute, an @slsMinorProtocolVersion attribute, an @slsPlpId attribute, an @slsDestinationIpAddress attribute, an @slsDestinationUdpPort attribute and/or an @slsSourceIpAddress attribute.

The @slsProtocol attribute may indicate the protocol used to deliver the SLS of the service (ROUTE, MMT, etc.). The @slsMajorProtocolVersion attribute and the @slsMinorProtocolVersion attribute may indicate the major version number and minor version number of the protocol used to deliver the SLS of the service, respectively.

The @slsPlpId attribute may provide a PLP identifier for identifying the PLP delivering the SLS of the service. In some embodiments, this field may be omitted and the PLP information delivered by the SLS may be checked using a combination of the information of the below-described LMT and the bootstrap information of the SLT.

The @slsDestinationIpAddress attribute, the @slsDestinationUdpPort attribute and the @slsSourceIpAddress attribute may indicate the destination IP address, destination UDP port and source IP address of the transport packets delivering the SLS of the service, respectively. These may identify the transport session (ROUTE session or MMTP session) delivered by the SLS. These may be included in the bootstrap information.

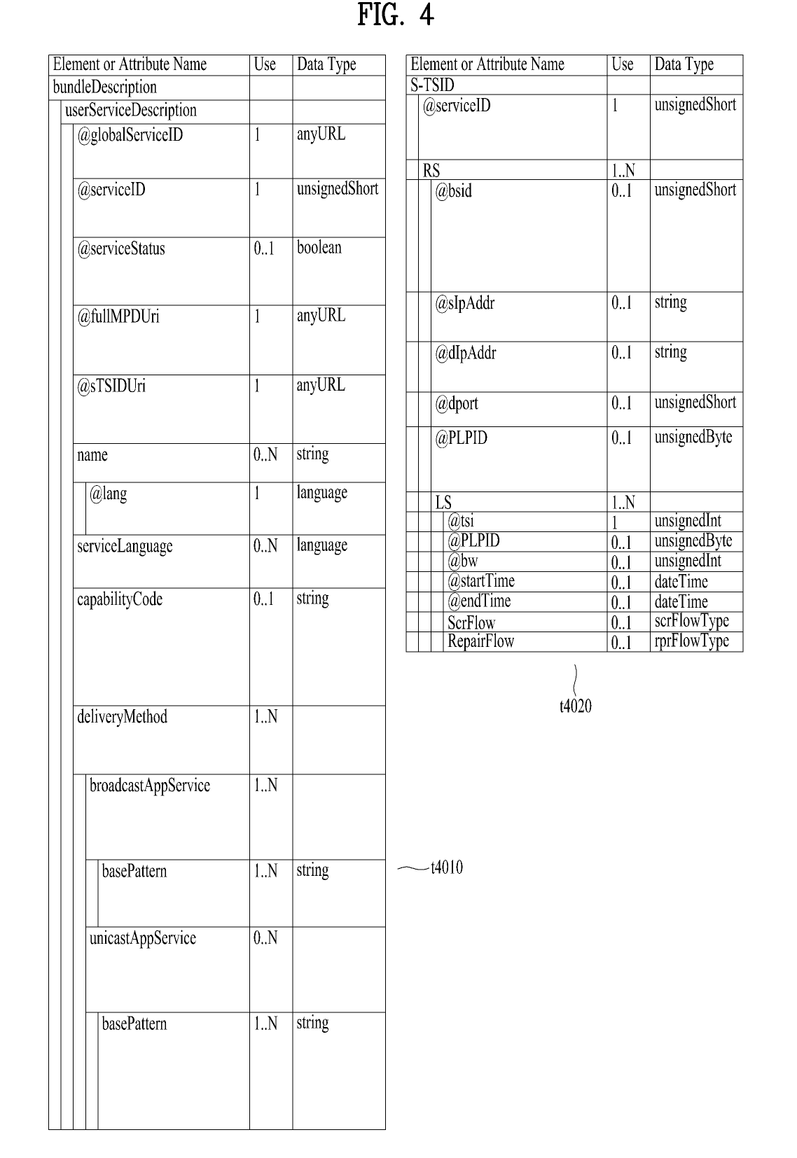

FIG. 4 is a diagram showing a USBD and an S-TSID delivered through ROUTE according to one embodiment of the present invention.

One embodiment t4010 of the shown USBD may have a bundleDescription root element. The bundleDescription root element may have a userServiceDescription element. The userServiceDescription element may be an instance of one service.

The userServiceDescription element may include an @globalServiceID attribute, an @serviceId attribute, an @serviceStatus attribute, an @fullMPDUri attribute, an @sTSIDUri attribute, a name element, a serviceLanguage element, a capabilityCode element and/or a deliveryMethod element. Each field may be omitted according to the value of the shown Use column or a plurality of fields may be present.

The @globalServiceID attribute is the globally unique identifier of the service and may be used for link with ESG data (Service@globalServiceID). The @serviceId attribute is a reference corresponding to the service entry of the SLT and may be equal to the service ID information of the SLT. The @service Status attribute may indicate the status of the service. This field may indicate whether the service is active or inactive.

The @fullMPDUri attribute may reference the MPD fragment of the service. The MPD may provide a reproduction description of a service component delivered over the broadcast or broadband network as described above. The @sTSIDUri attribute may reference the S-TSID fragment of the service. The S-TSID may provide parameters associated with access to the transport session carrying the service as described above.

The name element may provide the name of the service. This element may further include an @lang attribute and this field may indicate the language of the name provided by the name element. The serviceLanguage element may indicate available languages of the service. That is, this element may arrange the languages capable of being provided by the service.

The capabilityCode element may indicate capability or capability group information of a receiver necessary to significantly reproduce the service. This information is compatible with capability information format provided in service announcement.

The deliveryMethod element may provide transmission related information with respect to content accessed over the broadcast or broadband network of the service. The deliveryMethod element may include a broadcastAppService element and/or a unicastAppService element. Each of these elements may have a basePattern element as a sub element.

The broadcastAppService element may include transmission associated information of the DASH representation delivered over the broadcast network. The DASH representation may include media components over all periods of the service presentation.

The basePattern element of this element may indicate a character pattern used for the receiver to perform matching with the segment URL. This may be used for a DASH client to request the segments of the representation. Matching may imply delivery of the media segment over the broadcast network.

The unicastAppService element may include transmission related information of the DASH representation delivered over broadband. The DASH representation may include media components over all periods of the service media presentation.

The basePattern element of this element may indicate a character pattern used for the receiver to perform matching with the segment URL. This may be used for a DASH client to request the segments of the representation. Matching may imply delivery of the media segment over broadband.

One embodiment t4020 of the shown S-TSID may have an S-TSID root element. The S-TSID root element may include an @serviceId attribute and/or an RS element. Each field may be omitted according to the value of the shown Use column or a plurality of fields may be present.

The @serviceId attribute is the identifier of the service and may reference the service of the USBD/USD. The RS element may describe information on ROUTE sessions through which the service components of the service are delivered. According to the number of ROUTE sessions, a plurality of elements may be present. The RS element may further include an @bsid attribute, an @sIpAddr attribute, an @dIpAddr attribute, an @dport attribute, an @PLPID attribute and/or an LS element.

The @bsid attribute may be the identifier of a broadcast stream in which the service components of the service are delivered. If this field is omitted, a default broadcast stream may be a broadcast stream including the PLP delivering the SLS of the service. The value of this field may be equal to that of the @bsid attribute.

The @sIpAddr attribute, the @dIpAddr attribute and the @dport attribute may indicate the source IP address, destination IP address and destination UDP port of the ROUTE session, respectively. When these fields are omitted, the default values may be the source address, destination IP address and destination UDP port values of the current ROUTE session delivering the SLS, that is, the S-TSID. This field may not be omitted in another ROUTE session delivering the service components of the service, not in the current ROUTE session.

The @PLPID attribute may indicate the PLP ID information of the ROUTE session. If this field is omitted, the default value may be the PLP ID value of the current PLP delivered by the S-TSID. In some embodiments, this field is omitted and the PLP ID information of the ROUTE session may be checked using a combination of the information of the below-described LMT and the IP address/UDP port information of the RS element.

The LS element may describe information on LCT channels through which the service components of the service are transmitted. According to the number of LCT channel, a plurality of elements may be present. The LS element may include an @tsi attribute, an @PLPID attribute, an @bw attribute, an @startTime attribute, an @endTime attribute, a SrcFlow element and/or a RepairFlow element.

The @tsi attribute may indicate the tsi information of the LCT channel. Using this, the LCT channels through which the service components of the service are delivered may be identified. The @PLPID attribute may indicate the PLP ID information of the LCT channel. In some embodiments, this field may be omitted. The @bw attribute may indicate the maximum bandwidth of the LCT channel. The @startTime attribute may indicate the start time of the LCT session and the @endTime attribute may indicate the end time of the LCT channel.

The SrcFlow element may describe the source flow of ROUTE. The source protocol of ROUTE is used to transmit a delivery object and at least one source flow may be established within one ROUTE session. The source flow may deliver associated objects as an object flow.

The RepairFlow element may describe the repair flow of ROUTE. Delivery objects delivered according to the source protocol may be protected according to forward error correction (FEC) and the repair protocol may define an FEC framework enabling FEC protection.

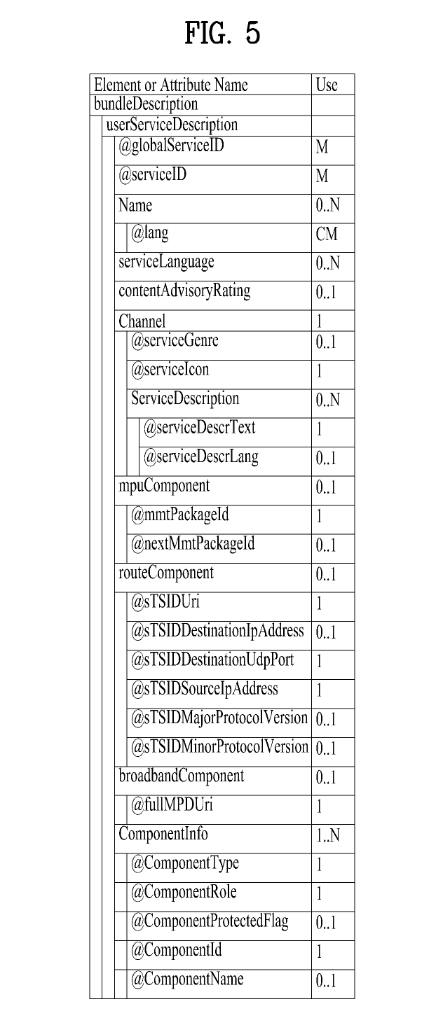

FIG. 5 is a diagram showing a USBD delivered through MMT according to one embodiment of the present invention.

One embodiment of the shown USBD may have a bundleDescription root element. The bundleDescription root element may have a userServiceDescription element. The userServiceDescription element may be an instance of one service.

The userServiceDescription element may include an @globalServiceID attribute, an @serviceId attribute, a Name element, a serviceLanguage element, a contentAdvisoryRating element, a Channel element, a mpuComponent element, a routeComponent element, a broadbandComponent element and/or a ComponentInfo element. Each field may be omitted according to the value of the shown Use column or a plurality of fields may be present.

The @globalServiceID attribute, the @serviceId attribute, the Name element and/or the serviceLanguage element may be equal to the fields of the USBD delivered through ROUTE. The contentAdvisoryRating element may indicate the content advisory rating of the service. This information is compatible with content advisory rating information format provided in service announcement. The Channel element may include information associated with the service. A detailed description of this element will be given below.

The mpuComponent element may provide a description of service components delivered as the MPU of the service. This element may further include an @mmtPackageId attribute and/or an @nextMmtPackageId attribute. The @mmtPackageId attribute may reference the MMT package of the service components delivered as the MPU of the service. The @nextMmtPackageId attribute may reference an MMT package to be used after the MMT package referenced by the @mmtPackageId attribute in terms of time. Through the information of this element, the MP table may be referenced.

The routeComponent element may include a description of the service components of the service. Even when linear service components are delivered through the MMT protocol, NRT data may be delivered according to the ROUTE protocol as described above. This element may describe information on such NRT data. A detailed description of this element will be given below.

The broadbandComponent element may include the description of the service components of the service delivered over broadband. In hybrid service delivery, some service components of one service or other files may be delivered over broadband. This element may describe information on such data. This element may further an @fullMPDUri attribute. This attribute may reference the MPD describing the service component delivered over broadband. In addition to hybrid service delivery, the broadcast signal may be weakened due to traveling in a tunnel and thus this element may be necessary to support handoff between broadband and broadband. When the broadcast signal is weak, the service component is acquired over broadband and, when the broadcast signal becomes strong, the service component is acquired over the broadcast network to secure service continuity.

The ComponentInfo element may include information on the service components of the service. According to the number of service components of the service, a plurality of elements may be present. This element may describe the type, role, name, identifier or protection of each service component. Detailed information of this element will be described below.

The above-described Channel element may further include an @serviceGenre attribute, an @serviceIcon attribute and/or a ServiceDescription element. The @serviceGenre attribute may indicate the genre of the service and the @serviceIcon attribute may include the URL information of the representative icon of the service. The ServiceDescription element may provide the service description of the service and this element may further include an @serviceDescrText attribute and/or an @serviceDescrLang attribute. These attributes may indicate the text of the service description and the language used in the text.

The above-described routeComponent element may further include an @sTSIDUri attribute, an @sTSIDDestinationIpAddress attribute, an @sTSIDDestinationUdpPort attribute, an @sTSIDSourceIpAddress attribute, an @sTSIDMajorProtocolVersion attribute and/or an @sTSIDMinorProtocolVersion attribute.

The @sTSIDUri attribute may reference an S-TSID fragment. This field may be equal to the field of the USBD delivered through ROUTE. This S-TSID may provide access related information of the service components delivered through ROUTE. This S-TSID may be present for NRT data delivered according to the ROUTE protocol in a state of delivering linear service component according to the MMT protocol.

The @sTSIDDestinationIpAddress attribute, the @sTSIDDestinationUdpPort attribute and the @sTSIDSourceIpAddress attribute may indicate the destination IP address, destination UDP port and source IP address of the transport packets carrying the above-described S-TSID. That is, these fields may identify the transport session (MMTP session or the ROUTE session) carrying the above-described S-TSID.

The @sTSIDMajorProtocolVersion attribute and the @sTSIDMinorProtocolVersion attribute may indicate the major version number and minor version number of the transport protocol used to deliver the above-described S-TSID, respectively.

The above-described ComponentInfo element may further include an @componentType attribute, an @componentRole attribute, an @componentProtectedFlag attribute, an @componentId attribute and/or an @componentName attribute.

The @componentType attribute may indicate the type of the component. For example, this attribute may indicate whether the component is an audio, video or closed caption component. The @componentRole attribute may indicate the role of the component. For example, this attribute may indicate main audio, music, commentary, etc. if the component is an audio component. This attribute may indicate primary video if the component is a video component. This attribute may indicate a normal caption or an easy reader type if the component is a closed caption component.

The @componentProtectedFlag attribute may indicate whether the service component is protected, for example, encrypted. The @componentId attribute may indicate the identifier of the service component. The value of this attribute may be the asset_id (asset ID) of the MP table corresponding to this service component. The @componentName attribute may indicate the name of the service component.

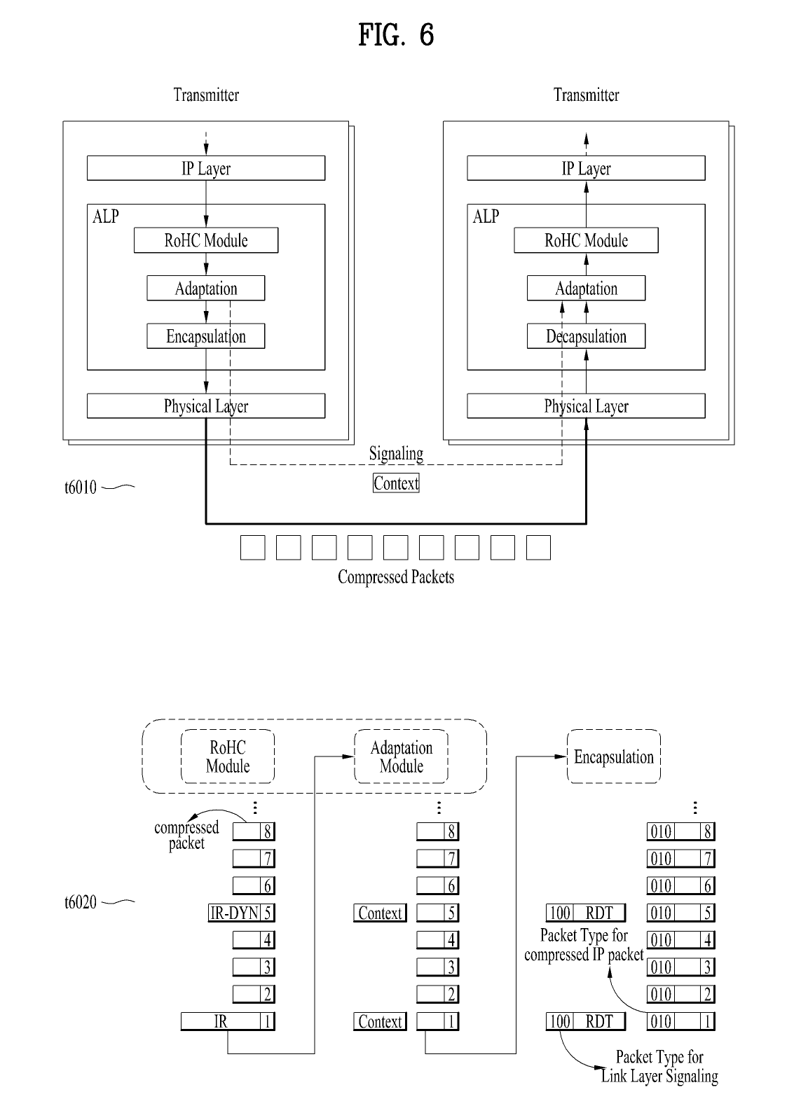

FIG. 6 is a diagram showing link layer operation according to one embodiment of the present invention.

The link layer may be a layer between a physical layer and a network layer. A transmission side may transmit data from the network layer to the physical layer and a reception side may transmit data from the physical layer to the network layer (t6010). The purpose of the link layer is to compress (abstract) all input packet types into one format for processing by the physical layer and to secure flexibility and expandability of an input packet type which is not defined yet. In addition, the link layer may provide option for compressing (abstracting) unnecessary information of the header of input packets to efficiently transmit input data. Operation such as overhead reduction, encapsulation, etc. of the link layer is referred to as a link layer protocol and packets generated using this protocol may be referred to as link layer packets. The link layer may perform functions such as packet encapsulation, overhead reduction and/or signaling transmission.

At the transmission side, the link layer (ALP) may perform an overhead reduction procedure with respect to input packets and then encapsulate the input packets into link layer packets. In addition, in some embodiments, the link layer may perform encapsulation into the link layer packets without performing the overhead reduction procedure. Due to use of the link layer protocol, data transmission overhead on the physical layer may be significantly reduced and the link layer protocol according to the present invention may provide IP overhead reduction and/or MPEG-2 TS overhead reduction.

When the shown IP packets are input as input packets (t6010), the link layer may sequentially perform IP header compression, adaptation and/or encapsulation. In some embodiments, some processes may be omitted. For example, the RoHC module may perform IP packet header compression to reduce unnecessary overhead. Context information may be extracted through the adaptation procedure and transmitted out of band. The IP header compression and adaption procedure may be collectively referred to as IP header compression. Thereafter, the IP packets may be encapsulated into link layer packets through the encapsulation procedure.

When MPEG 2 TS packets are input as input packets, the link layer may sequentially perform overhead reduction and/or an encapsulation procedure with respect to the TS packets. In some embodiments, some procedures may be omitted. In overhead reduction, the link layer may provide sync byte removal, null packet deletion and/or common header removal (compression). Through sync byte removal, overhead reduction of 1 byte may be provided per TS packet. Null packet deletion may be performed in a manner in which reinsertion is possible at the reception side. In addition, deletion (compression) may be performed in a manner in which common information between consecutive headers may be restored at the reception side. Some of the overhead reduction procedures may be omitted. Thereafter, through the encapsulation procedure, the TS packets may be encapsulated into link layer packets. The link layer packet structure for encapsulation of the TS packets may be different from that of the other types of packets.

First, IP header compression will be described.

The IP packets may have a fixed header format but some information necessary for a communication environment may be unnecessary for a broadcast environment. The link layer protocol may compress the header of the IP packet to provide a mechanism for reducing broadcast overhead.

IP header compression may employ a header compressor/decompressor and/or an adaptation module. The IP header compressor (RoHC compressor) may reduce the size of each IP packet header based on the RoHC scheme. Thereafter, the adaptation module may extract context information and generate signaling information from each packet stream. A receiver may parse signaling information associated with the packet stream and attach context information to the packet stream. The RoHC decompressor may restore the packet header to reconfigure an original IP packet. Hereinafter, IP header compression may mean only IP header compression by a header compression or a combination of IP header compression and an adaptation process by an adaptation module. The same is true in decompressing.

Hereinafter, adaptation will be described.

In transmission of a single-direction link, when the receiver does not have context information, the decompressor cannot restore the received packet header until complete context is received. This may lead to channel change delay and turn-on delay. Accordingly, through the adaptation function, configuration parameters and context information between the compressor and the decompressor may be transmitted out of band. The adaptation function may provide construction of link layer signaling using context information and/or configuration parameters. The adaptation function may use previous configuration parameters and/or context information to periodically transmit link layer signaling through each physical frame.

Context information is extracted from the compressed IP packets and various methods may be used according to adaptation mode.

Mode #1 refers to a mode in which no operation is performed with respect to the compressed packet stream and an adaptation module operates as a buffer.

Mode #2 refers to a mode in which an IR packet is detected from a compressed packet stream to extract context information (static chain). After extraction, the IR packet is converted into an IR-DYN packet and the IR-DYN packet may be transmitted in the same order within the packet stream in place of an original IR packet.

Mode #3 (t6020) refers to a mode in which IR and IR-DYN packets are detected from a compressed packet stream to extract context information. A static chain and a dynamic chain may be extracted from the IR packet and a dynamic chain may be extracted from the IR-DYN packet. After extraction, the IR and IR-DYN packets are converted into normal compression packets. The converted packets may be transmitted in the same order within the packet stream in place of original IR and IR-DYN packets.

In each mode, the context information is extracted and the remaining packets may be encapsulated and transmitted according to the link layer packet structure for the compressed IP packets. The context information may be encapsulated and transmitted according to the link layer packet structure for signaling information, as link layer signaling.

The extracted context information may be included in a RoHC-U description table (RDT) and may be transmitted separately from the RoHC packet flow. Context information may be transmitted through a specific physical data path along with other signaling information. The specific physical data path may mean one of normal PLPs, a PLP in which low level signaling (LLS) is delivered, a dedicated PLP or an L1 signaling path. Here, the RDT may be context information (static chain and/or dynamic chain) and/or signaling information including information associated with header compression. In some embodiments, the RDT shall be transmitted whenever the context information is changed. In addition, in some embodiments, the RDT shall be transmitted every physical frame. In order to transmit the RDT every physical frame, the previous RDT may be reused.

The receiver may select a first PLP and first acquire signaling information of the SLT, the RDT, the LMT, etc., prior to acquisition of a packet stream. When signaling information is acquired, the receiver may combine the signaling information to acquire mapping between service-IP information-context information-PLP. That is, the receiver may check which service is transmitted in which IP streams or which IP streams are delivered in which PLP and acquire context information of the PLPs. The receiver may select and decode a PLP carrying a specific packet stream. The adaptation module may parse context information and combine the context information with the compressed packets. To this end, the packet stream may be restored and delivered to the RoHC decompressor. Thereafter, decompression may start. At this time, the receiver may detect IR packets to start decompression from an initially received IR packet (mode 1), detect IR-DYN packets to start decompression from an initially received IR-DYN packet (mode 2) or start decompression from any compressed packet (mode 3).

Hereinafter, packet encapsulation will be described.

The link layer protocol may encapsulate all types of input packets such as IP packets, TS packets, etc. into link layer packets. To this end, the physical layer processes only one packet format independently of the protocol type of the network layer (here, an MPEG-2 TS packet is considered as a network layer packet). Each network layer packet or input packet is modified into the payload of a generic link layer packet.

In the packet encapsulation procedure, segmentation may be used. If the network layer packet is too large to be processed in the physical layer, the network layer packet may be segmented into two or more segments. The link layer packet header may include fields for segmentation of the transmission side and recombination of the reception side. Each segment may be encapsulated into the link layer packet in the same order as the original location.

In the packet encapsulation procedure, concatenation may also be used. If the network layer packet is sufficiently small such that the payload of the link layer packet includes several network layer packets, concatenation may be performed. The link layer packet header may include fields for performing concatenation. In concatenation, the input packets may be encapsulated into the payload of the link layer packet in the same order as the original input order.

The link layer packet may include a header and a payload. The header may include a base header, an additional header and/or an optional header. The additional header may be further added according to situation such as concatenation or segmentation and the additional header may include fields suitable for situations. In addition, for delivery of the additional information, the optional header may be further included. Each header structure may be pre-defined. As described above, if the input packets are TS packets, a link layer header having packets different from the other packets may be used.

Hereinafter, link layer signaling will be described.

Link layer signaling may operate at a level lower than that of the IP layer. The reception side may acquire link layer signaling faster than IP level signaling of the LLS, the SLT, the SLS, etc. Accordingly, link layer signaling may be acquired before session establishment.

Link layer signaling may include internal link layer signaling and external link layer signaling. Internal link layer signaling may be signaling information generated at the link layer. This includes the above-described RDT or the below-described LMT. External link layer signaling may be signaling information received from an external module, an external protocol or a higher layer. The link layer may encapsulate link layer signaling into a link layer packet and deliver the link layer packet. A link layer packet structure (header structure) for link layer signaling may be defined and link layer signaling information may be encapsulated according to this structure.

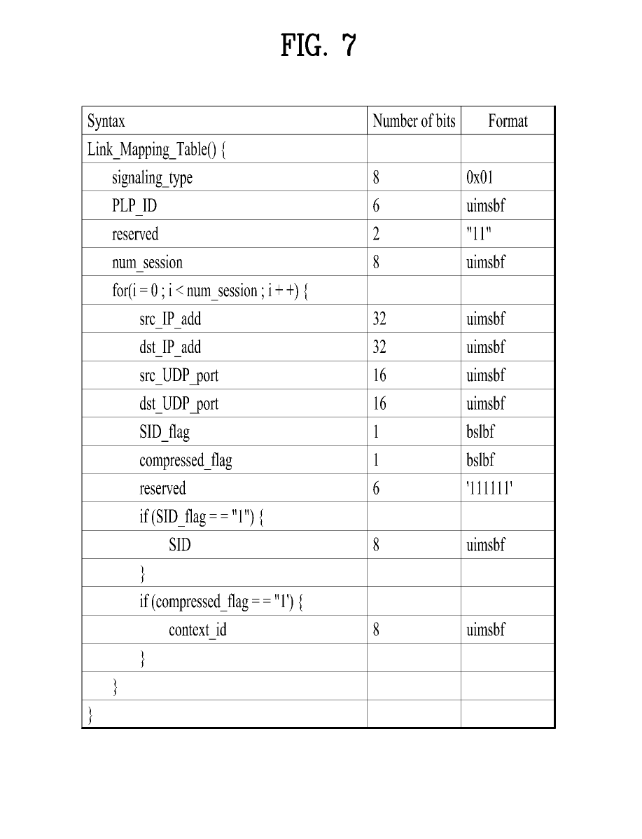

FIG. 7 is a diagram showing a link mapping table (LMT) according to one embodiment of the present invention.

The LMT may provide a list of higher layer sessions carried through the PLP. In addition, the LMT may provide additional information for processing link layer packets carrying the higher layer sessions. Here, the higher layer sessions may be called multicast. Information on IP streams or transport sessions transmitted through a specific PLP may be acquired through the LMT. In contrast, information on through which PLP a specific transport session is delivered may be acquired.

The LMT can be delivered through any PLP which is identified as carrying LLS. Here, a PLP through which LLS is delivered can be identified by an LLS flag of L1 detail signaling information of the physical layer. The LLS flag may be a flag field indicating whether LLS is delivered through a corresponding PLP for each PLP. Here, the L1 detail signaling information may correspond to PLS2 data which will be described below.

That is, the LMT can be delivered along with the LLS through the same PLP. Each LMT can describe mapping between PLPs and IP addresses/ports as described above. The LLS may include an SLT, as described above. An IP address/port described by the LMT may be any IP address/port related to any service described by the SLT delivered through the same PLP as that used to deliver the LMT.

In some embodiments, the PLP identifier information in the above-described SLT, SLS, etc. may be used to confirm information indicating through which PLP a specific transport session indicated by the SLT or SLS is transmitted may be confirmed.

In another embodiment, the PLP identifier information in the above-described SLT, SLS, etc. will be omitted and PLP information of the specific transport session indicated by the SLT or SLS may be confirmed by referring to the information in the LMT. In this case, the receiver may combine the LMT and other IP level signaling information to identify the PLP. Even in this embodiment, the PLP information in the SLT, SLS, etc. is not omitted and may remain in the SLT, SLS, etc.

The LMT according to the shown embodiment may include a signaling_type field, a PLP_ID field, a num_session field and/or information on each session. Although the LMT of the shown embodiment describes IP streams transmitted through one PLP, a PLP loop may be added to the LMT to describe information on a plurality of PLPs in some embodiments.

The signaling_type field may indicate the type of signaling information delivered by the table. The value of signaling_type field for the LMT may be set to 0x01. The signaling_type field may be omitted. The PLP_ID field may identify a PLP which is a target to be described. When a PLP loop is used, each PLP_ID field can identify each target PLP. The PLP_ID field and following fields may be included in a PLP loop. The PLP_ID field which will be mentioned below is an ID of one PLP in a PLP loop and fields which will be described below may be fields with respect to the corresponding PLP.

The num_session field may indicate the number of higher layer sessions delivered through the PLP identified by the corresponding PLP_ID field. According to the number indicated by the num_session field, information on each session may be included. This information may include a src_IP_add field, a dst_IP_add field, a src_UDP_port field, a dst_UDP_port field, an SID_flag field, a compressed_flag field, an SID field and/or a context_id field.

The src_IP_add field, the dst_IP_add field, the src_UDP_port field and the dst_UDP_port field may indicate the source IP address, the destination IP address, the source UDP port and the destination UDP port of the transport session among the higher layer sessions delivered through the PLP identified by the corresponding PLP_ID field.

The SID_flag field may indicate whether the link layer packet delivering the transport session has an SID field in the optional header. The link layer packet delivering the higher layer session may have an SID field in the optional header and the SID field value may be equal to that of the SID field in the LMT.

The compressed_flag field may indicate whether header compression is applied to the data of the link layer packet delivering the transport session. In addition, presence/absence of the below-described context_id field may be determined according to the value of this field. When header compression is applied (compressed_field=1), an RDT can be present and a PLP ID field of the RDT can have the same value as the PLP_ID field related to the compressed_flag field.

The SID field may indicate the SIDs (sub stream IDs) of the link layer packets delivering the transport session. The link layer packets may include an SID having the same values as the SID field in the optional headers thereof. Accordingly, the receiver can filter link layer packets using information of the LMT and SID information of link layer packet headers without parsing all of the link layer packets.

The context_id field may provide a reference for a context id (CID) in the RDT. The CID information of the RDT may indicate the context ID of the compression IP packet stream. The RDT may provide context information of the compression IP packet stream. Through this field, the RDT and the LMT may be associated.

In the above-described embodiments of the signaling information/table of the present invention, the fields, elements or attributes may be omitted or may be replaced with other fields. In some embodiments, additional fields, elements or attributes may be added.

In one embodiment of the present invention, service components of a service can be delivered through a plurality of ROUTE sessions. In this case, the SLS can be acquired through bootstrap information of an SLT. S-TSID and MPD can be referenced through USBD of the SLS. The S-TSID can describe not only a ROUTE session through which the SLS is delivered but also transport session description information about other ROUTE sessions through which the service components are delivered. Accordingly, all the service components delivered through the multiple ROUTE sessions can be collected. This can be equally applied to a case in which service components of a service are delivered through a plurality of MMTP sessions. For reference, one service component may be simultaneously used by multiple services.

In another embodiment of the present invention, bootstrapping for an ESG service can be performed through a broadcast network or a broadband. URL information of an SLT can be used by acquiring an ESG through a broadband. A request for ESG information may be sent to the URL.

In another embodiment of the present invention, one of the service components of a service can be delivered through a broadcast network and another service component may be delivered over a broadband (hybrid). The S-TSID describes components delivered over a broadcast network such that a ROUTE client can acquire desired service components. In addition, the USBD has base pattern information and thus can describe which segments (which components) are delivered and paths through which the segments are delivered. Accordingly, a receiver can recognize segments that need to be requested from a broadband server and segments that need to be detected from broadcast streams using the USBD.

In another embodiment of the present invention, scalable coding for a service can be performed. The USBD may have all pieces of capability information necessary to render the corresponding service. For example, when a HD or UHD service is provided, the capability information of the USBD may have a value of “HD UHD”. The receiver can recognize which component needs to be presented to render a UHD or HD service using the MPD.

In another embodiment of the present invention, SLS fragments delivered (USBD, S-TSID, MPD or the like) by LCT packets delivered through an LCT channel which delivers the SLS can be identified through a TOI field of the LCT packets.

In another embodiment of the present invention, application components to be used for application based enhancement/app based service can be delivered over a broadcast network or a broadband as NRT components. In addition, application signaling for application based enhancement can be performed by an AST (Application Signaling Table) delivered along with the SLS. Further, an event which is signaling for an operation to be executed by an application may be delivered in the form of an EMT (Event Message Table) along with the SLS, signaled in MPD, or in-band signaled in the form of a box in DASH representation. The AST and the EMT may be delivered over a broadband. Application based enhancement can be provided using collected application components and the aforementioned signaling information.

In another embodiment of the present invention, a CAP message may be included in the aforementioned LLS table and provided for emergency alert. Rich media content for emergency alert may also be provided. Rich media may be signaled through a CAP message. When rich media are present, the rich media can be provided as an EAS service signaled through an SLT.

In another embodiment of the present invention, linear service components can be delivered through a broadcast network according to the MMT protocol. In this case, NRT data (e.g., application component) regarding the corresponding service can be delivered through a broadcast network according to the ROUTE protocol. In addition, data regarding the corresponding service may be delivered over a broadband. The receiver can access an MMTP session through which the SLS is delivered using bootstrap information of the SLT. The USBD of the SLS according to the MMT can reference an MP table to allow the receiver to acquire linear service components formatted into MPU and delivered according to the MMT protocol. Furthermore, the USBD can further reference S-TSID to allow the receiver to acquire NRT data delivered according to the ROUTE protocol. Moreover, the USBD can further reference the MPD to provide reproduction description for data delivered over a broadband.

In another embodiment of the present invention, the receiver can deliver location URL information through which streaming components and/or file content items (files, etc.) can be acquired to a companion device thereof through a method such as web socket. An application of the companion device can acquire corresponding component data by sending a request to the URL through HTTP GET. In addition, the receiver can deliver information such as system time information and emergency alert information to the companion device.

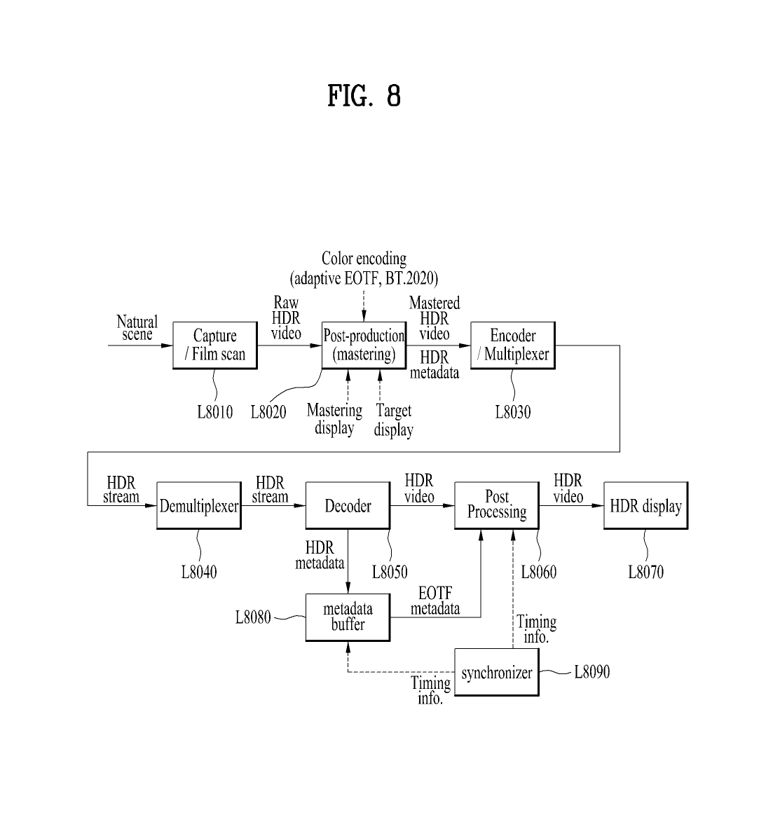

FIG. 8 is a diagram illustrating a structure of a transceiving system for adaptive EOTF based HDR broadcast services according to an embodiment of the present invention.

A broadcast system according to an embodiment of the present invention provides adaptive electro-optical transfer function (EOTF) based high dynamic range (HDR) broadcast services. An EOTF is a function used to convert an electronic video signal into an optical video signal at a receiver for video decoding. An OETF is a function used to convert an optical video signal into an electronic video signal at a transmitter for video encoding. HDR content refers to content having a wide dynamic range and standard dynamic range (SDR) content or low dynamic range (LDR) content refers to content having a narrow dynamic range. The dynamic range of content represents a range of luminance of content.

When HDR content which can represent a wide range of luminance is provided, the broadcast system according to an embodiment of the present invention can consider a characteristic difference between the HDR content and a display using an adaptive EOTF and thus can provide optimized picture quality to viewers.

UHD broadcast can provide differentiation from conventional broadcast and a high degree of presence by representing luminance which cannot be represented in conventional content. Introduction of HDR increases a dynamic range of images and thus a characteristic difference between scenes of content further increases. The broadcast system according to an embodiment of the present invention provides information for effectively presenting characteristics of scenes on a display and a receiver provides video effects on the basis of the information, and thus viewers can view images through a method adapted for the intention of a producer.

A transmitter according to an embodiment of the present invention can deliver information about an HDR EOTF which varies according to content or a scene to the receiver. Specifically, the transmitter can deliver information about a unit in which the HDR EOTF varies and/or adaptive information in consideration of characteristics of content and displays.

The broadcast system according to an embodiment of the present invention can provide an environment in which HDR video with enhanced picture quality through metadata is viewed. The metadata transmitted according to an embodiment of the present invention signals parameter information about the adaptive EOTF and the receiver can improve picture quality or a viewing environment using the metadata by applying different EOTFs depending on content/scenes and target displays.

The figure illustrates the structure of the broadcast system according to an embodiment of the present invention. The broadcast system according to an embodiment of the present invention includes a capture/film scan unit L8010, a post-production (mastering) unit L8020, an encoder/multiplexer L8030, a demultiplexer L8040, a decoder L8050, a post-processing unit L8060, an HDR display L8070, a metadata buffer L8080 and/or a synchronizer L8090. The capture/film scan unit L8010 captures and scans natural scenes to generate raw HDR video. The post-production (mastering) unit L8020 masters the HDR video to generate mastered HDR video and HDR metadata for signaling characteristics of the mastered HDR video. To master the HDR video color encoding information (adaptive EOTF, BT.2020), information about a mastering display, information about a target display, and the like may be used. The encoder/multiplexer L8030 encodes the mastered HDR video to generate HDR streams and performs multiplexing with other streams to generate broadcast streams. The demultiplexer L8040 receives and demultiplexes the broadcast streams to generate HDR streams (HDR video streams). The decoder L8050 decodes the HDR streams to output the HDR video and the HDR metadata. The metadata buffer L8080 receives the HDR metadata and delivers EOTF metadata among the HDR metadata to the post-processing unit. The post-processing unit L8060 post-processes the HDR video delivered from the decoder using the EOTF metadata and/or timing information. The HDR display L8070 displays the post-processed HDR video.

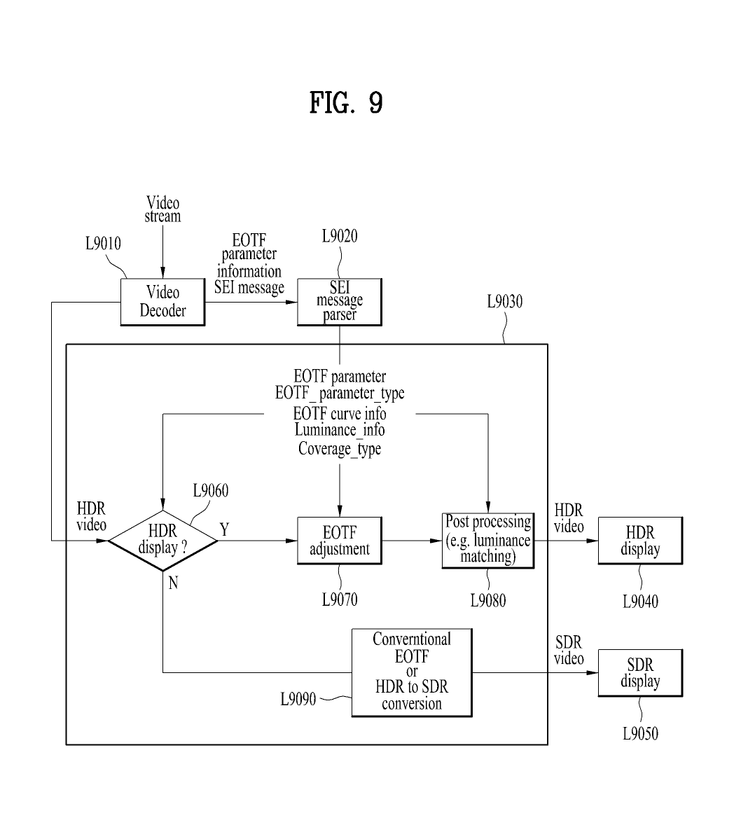

FIG. 9 is a diagram illustrating a structure of a receiver according to an embodiment of the present invention.

In the specification, description is based on receiver operation to which the present invention is applied. However, details of signaling information which causes the receiver operation may be applied to a transmitter and the signaling information may also be applied to a production procedure and/or a mastering procedure.

The receiver according to an embodiment of the present invention receives a video stream, extracts an SEI message from the video stream and stores the SEI message in a separate buffer. The receiver determines the performance thereof, appropriately configures an EOTF applied to video using an EOTF parameter and displays final video. In the specification, EOTF has the same meaning as OETF.

The receiver according to an embodiment of the present invention includes a video decoder L9010, an SEI message parser L9020, a post-processing unit L9030, an HDR display and/or an SDR display. The first post-processing unit L9030 includes an HDR display determination unit L9060, an EOTF adjustment unit L9070, a second post-processing unit L9080 and/or a conversion unit (conventional EOTF or HDR to SDR conversion) L9090. The first post-processing unit L9030 is the same as the post-processing unit described above in the preceding figure.

The receiver according to an embodiment of the present invention receives and decodes a video stream and acquires EOTF parameter information (EOTF_parameter_info( )). The video decoder L9010 decodes the video stream and delivers metadata (SEI message) acquired from the video stream to the metadata parser (SEI message parser) L9020. The SEI message parser L9020. The SEI message parser L9020 analyzes the metadata and then stores the metadata in a memory (buffer). The EOTF parameter information includes EOTF_parameter_type, EOTF parameters, luminance_information, etc.

The receiver according to an embodiment of the present invention determines whether the display thereof supports HDR and configures an EOTF. The HDR display determination unit L9060 determines whether the display of the receiver supports HDR. Further, the HDR display determination unit L9060 determines whether content received by the receiver can be presented on the basis of the EOTF parameter information, information about the content and/or information about a mastering display. When the HDR display determination unit L9060 determines that the receiver is not suited to present the content, the receiver can be determined to be an SDR display or a display having capabilities between SDR and HDR.

According to an embodiment of the present invention, when the HDR display determination unit L9060 determines that the display of the receiver is not suitable to present the received content (when the display is an SDR display or a display having capabilities similar to SDR), the receiver does not present the content or converts HDR content into SDR content for reproduction. According to another embodiment of the present invention, when the EOTF applied to the HDR content is compatible with the EOTF used for the SDR content, the HDR content can be presented through the SDR display without being subjected to an additional conversion procedure. In this case, the EOTF compatible with the EOTF used for the SDR content may have values such as transfer_characteristics of VUI=1, 6, 14, 15. In this case, additional processing for signaling analysis is not needed.

According to an embodiment of the present invention, when the HDR display determination unit L9060 determines that the display of the receiver is suitable to present the received content, the (HDR display) EOTF adjustment unit L9070 can adjust the EOTF used to encode the HDR content using the EOTF parameter information. After the adjusted EOTF is applied, the second post-processing unit L9080 may perform tone mapping of a dynamic range used for the content using EOTF_luminance_max/min information included in the EOTF parameter information. The HDR video post-processed by the second post-processing unit L9080 can be displayed through an HDR display.

According to an embodiment of the present invention, EOTFs having different variables can be used depending on display luminances of the receiver and/or luminances of content. For example, it is possible to efficiently maintain low or normal luminance and efficiently suppress high luminance by using an EOTF having a variable a for content having maximum luminance of 1,000 nit and using an EOTF having a different EOTF having a variable a′ when the maximum luminance increases to 5,000 nit. Here, information related to the above-described embodiments can be delivered through the EOTF parameter information according to an embodiment of the present invention, and luminance to which a corresponding EOTF is applied can be provided using luminance_information.

According to an embodiment, absolute luminance information can be delivered using luminance_information for an EOTF which represents relative luminance. For example, information about absolute luminance may be needed in a process of post-processing relative luminance based content. In this case, the necessary information can be delivered through luminance_information according to an embodiment of the present invention.

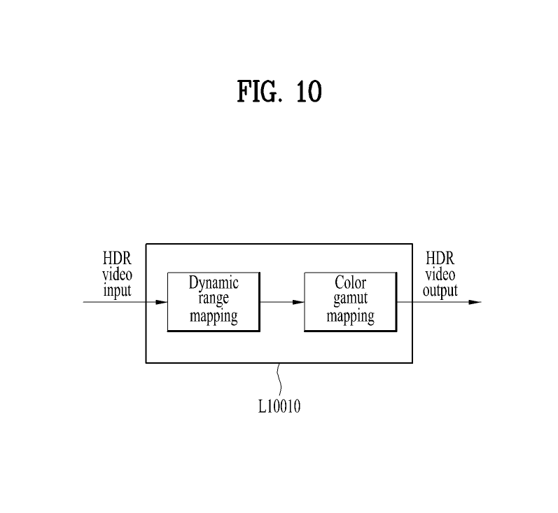

FIG. 10 is a diagram illustrating the operation of a second post-processing unit according to an embodiment of the present invention.

The second post-processing unit L10010 according to an embodiment of the present invention is the same as the second post-processing unit illustrated in the preceding figure. The second post-processing unit L10010 receives HDR video to which an adjusted EOTF has been applied and performs dynamic range mapping and color gamut mapping.

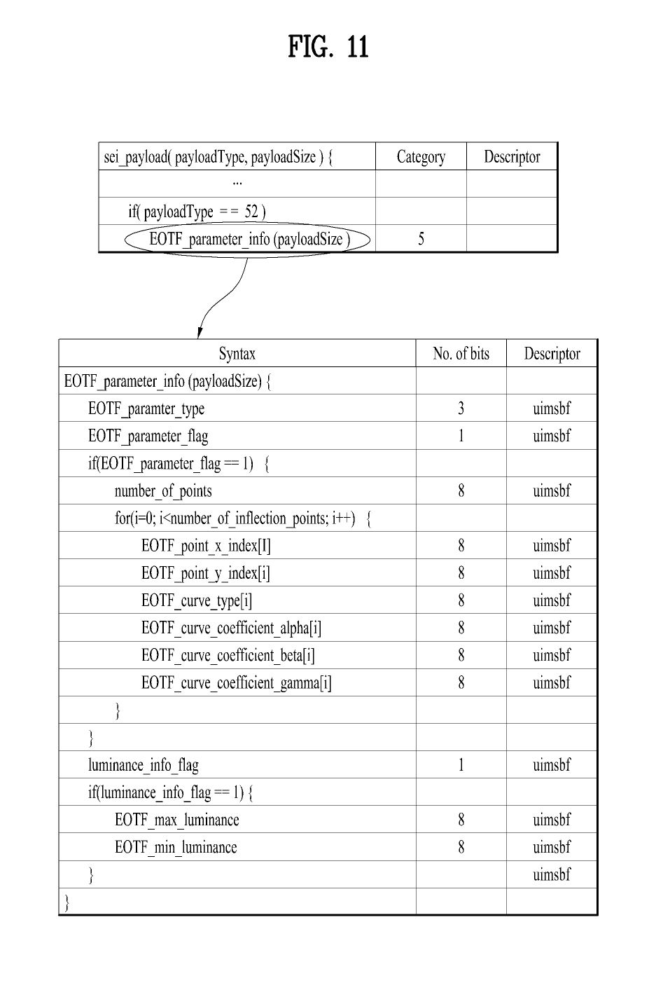

FIG. 11 is a diagram illustrating a configuration of an EOTF_parameter_info SEI (supplemental enhancement information) message according to an embodiment of the present invention.

The broadcast system according to an embodiment of the present invention can deliver information about presence or absence of an EOTF parameter to a receiver through an SEI message of video, or a PMT or EIT which are system information.

The broadcast system according to an embodiment of the present invention can define an EOTF type through a VUI (video usability information) message and deliver supplementary information through an SEI message and/or system information.

The broadcast system according to an embodiment of the present invention can deliver information indicating an HDR EOTF using VUI, an SEI message and/or system information for compatibility with a system having a previous EOTF.

According to an embodiment of the present invention, the EOTF_parameter_info SEI message may have a payload type value of 52, and a payload includes EOTF parameter information (EOTF_parameter_info).

The EOTF parameter information according to an embodiment of the present invention includes an EOTF_parameter_type, an EOTF_parameter_flag, a number_of_points, an EOTF_point_x_index[i], an EOTF_curve_type[i], an EOTF_curve_coefficient_alpha[i], an EOTF_curve_coefficient_beta[i], an EOTF_curve_coefficient_gamma[i], a luminance_info_flag, an EOTF_max_luminance and/or an EOTF_min_luminance.

The EOTF_parameter_type indicates the type of an EOTF used for video encoding. According to an embodiment of the present invention, VUI signal EOTFs belonging to a specific category (e.g., a gamma function EOTF and a parametric EOTF similar thereto belong to the same category) and this field (EOTF_parameter_type=parametric_EOTF_type) can identify the EOTFs in the specific category. According to another embodiment of the present invention, an EOTF type identified by this field and an EOTF type identified by VUI may be included in categories at the same level. For example, this field (parametric_EOTF_type) can be set to 1 in order to indicate an EOTF in consideration of backward compatibility in which inflection points vary according to luminance of content.

The EOTF_parameter_flag indicates whether a specific parameter for representing an EOTF exists. This field indicates presence of the parameter for the EOTF when set to 1.

The number_of_points indicates the number of inflection points for identifying luminance sections when the EOTF indicated by the EOTF_parameter_type has different characteristics for luminance sections.

The EOTF_point_x_index and the EOTF_point_y_index indicate a position of an inflection point of an EOTF. Here, the EOTF_point_x_index may indicate a normalized digital value and the EOTF_point_y_index may indicate absolute luminance or normalized relative luminance.

The EOTF_curve_type indicates a type of a curve used in each luminance section. For example, this field can indicate a linear function when set to 0x00, a logarithmic function when set to 0x01, an exponential function when set to 0x02, an inverse s-curve when set to 0x03, piecewise non-linear curves when set to 0x04, a look-up table when set to 0x05, and reserved values when set to 0x06 to 0xFF.

The EOTF_curve_coefficient_alpha, the EOTF_curve_coefficient_beta and the EOTF_curve_coefficient_gamma can additionally deliver coefficient information according to EOTF_curve_type. The number of coefficients is determined depending on EOTF_curve_type, and coefficients other than alpha, beta and gamma indicated by these fields may be added as necessary. According to an embodiment of the present invention, when an LUT is delivered as an EOTF type, an output value (out_value) corresponding to an input value (in_value) instead of a coefficient can be signaled. When the broadcast system according to an embodiment of the present invention includes all luminance values within a mapping range, the broadcast system may not transmit an input value (in_value) of the LUT and may signal only a difference between an output value (out_value) and a luminance value instead of signaling the output value.

The luminance_info_flag indicates whether information about a luminance range related to an EOTF exists. This field indicates presence of information about the luminance range related to the EOTF when set to 1.

EOTF_max_luminance and EOTF_min_luminance indicate maximum luminance and minimum luminance matched to an EOTF. These fields may have values in the range of 0 to 10,000. Here, a value of the EOTF_max_luminance may be greater than a value of the EOTF_min_luminance. According to an embodiment of the present invention, since even an absolute luminance based EOTF does use all code values, only a luminance range within which values actually exist can be signaled. For example, when an EOTF defined in SMPTE ST 2084 is used and only a graph corresponding to a luminance range of an image is used, the EOTF_max_luminance and EOTF_min_luminance fields can be used. In this case, additional EOTF related signaling may be needed. In the case of a relative luminance based EOTF, these fields indicate information about an actual luminance range considered in content. The receiver can replace relative luminance of content by absolute luminance using the values of these fields and display the content.

According to an embodiment of the present invention, the EOTF parameter information can be varied with time. In this case, a luminance range to which a corresponding EOTF is applied, start time, end time, information indicating whether the EOTF is changed and/or information about a parameter to be changed can be signaled.

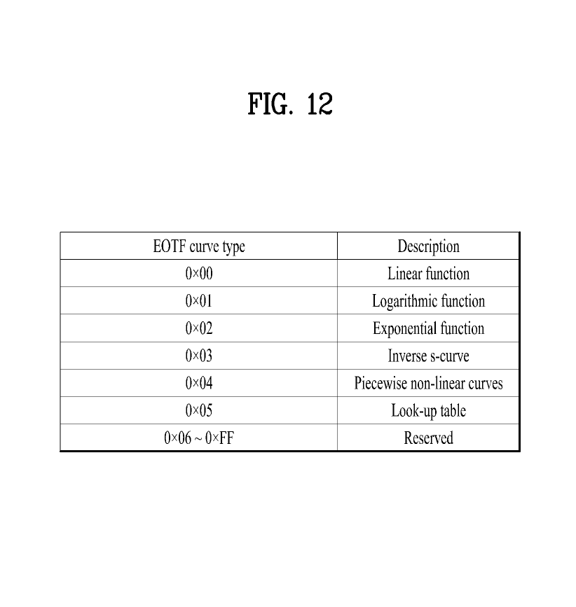

FIG. 12 is a diagram illustrating description of values of the EOTF_curve_type field according to an embodiment of the present invention.

While this figure illustrates values of the EOTF_curve_type field according to an embodiment of the present invention, the values of the EOTF_curve_type field have been described in detail in the preceding figure.

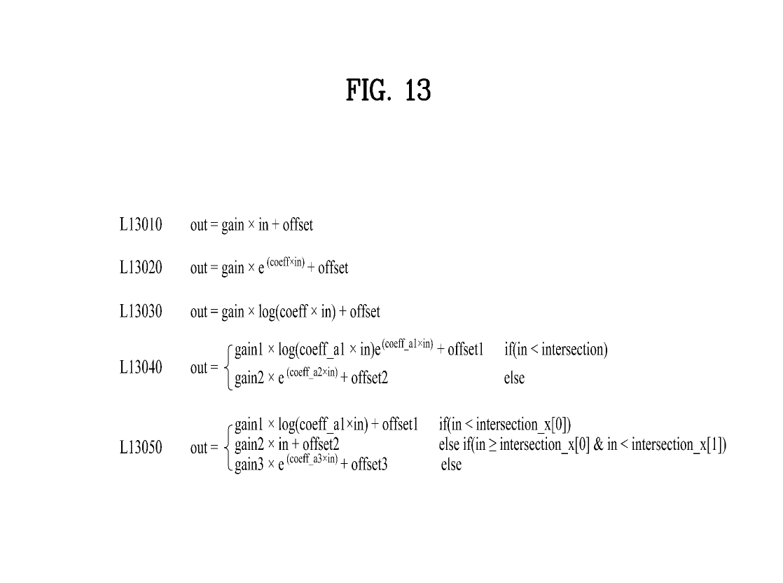

FIG. 13 is a diagram illustrating functional formulas of a curve according to values of the EOTF_curve_type field according to an embodiment of the present invention.

In this figure, L13010, L13020, L13030, L13040 and L13050 respectively represent functional formulas of a linear function, a logarithmic function, an exponential function, an inverse S-curve and piecewise non-linear curves.

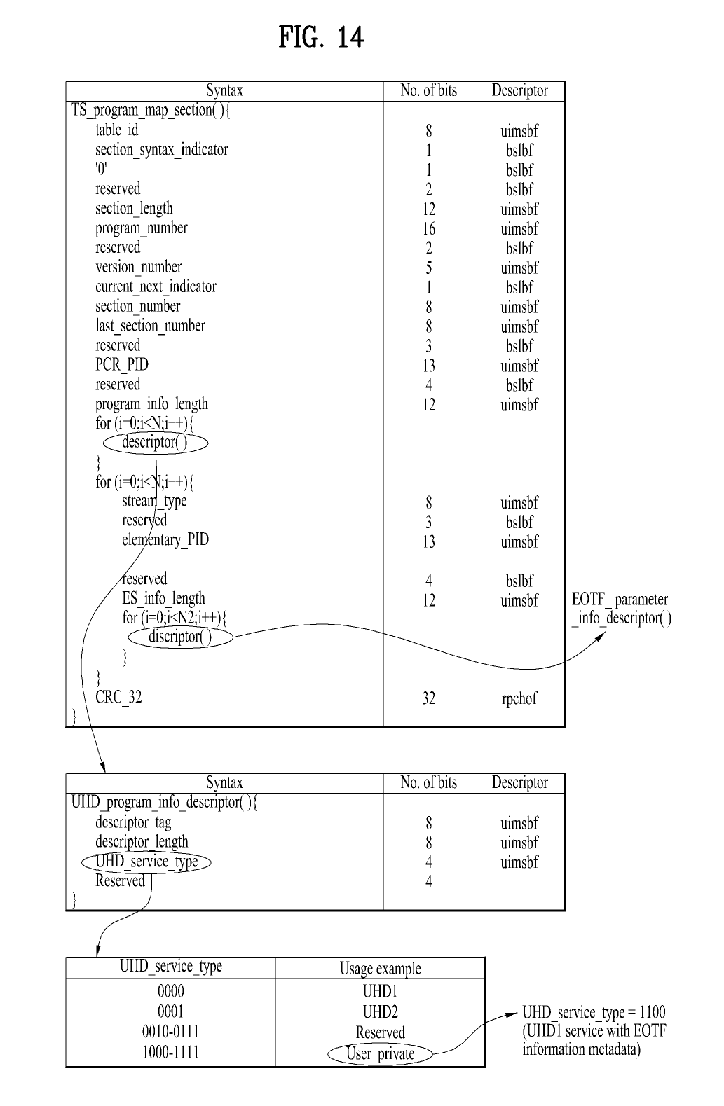

FIG. 14 is a diagram illustrating a case in which EOTF parameter information according to an embodiment of the present invention is signaled through a PMT (program map table).

The broadcast system according to an embodiment of the present invention can signal EOTF parameter information using a PMT and/or an EIT (event information table) of a system level as well as an SEI message and further signal that a corresponding service is a UHD service using the EOTF parameter information.

The EOTF parameter information according to an embodiment of the present invention has a descriptor form (EOTF_parameter_info_descriptor) and may be included in a descriptor of a stream level of a PMT.

A UHD_program_info_descriptor according to an embodiment of the present invention may be included in a descriptor of a program level of a PMT. The UHD_program_info_descriptor includes descriptor_tag, descriptor_length and/or UHD_service_type fields. The descriptor_tag indicates that the descriptor is a UHD_program_info_descriptor. The descriptor_length indicates the length of the descriptor. The UHD_service_type indicates the type of the service. The UHD_service_type indicates UHD1 when set to 0000, UHD2 when set to 0001, reserved values when set to 0010 to 0111, and user private when set to 1000 to 1111. The UHD service type according to an embodiment of the present invention provides information about types of UHD services (e.g., UHD service types designated by a user, such as UHD1 (4K), UHD2 (8K) and types classified according to definitions). Accordingly, the broadcast system according to an embodiment of the present invention can provide various UHD services. The broadcast system according to an embodiment of the present invention can set the UHD_service_type to 1100 (UHD1 service with EOTF parameter information (=EOTF information metadata), an example of 4K) to indicate that HDR video information based on an adaptive EOTF is provided.

A PMT according to an embodiment of the present invention includes a table_id field, a section_syntax_indicator field, a section_length field, a program_number field, a version_number field, a current_next_indicator field, a section_number field, a last_section_number field, a PCR_PID field, a program_info_length field, a descriptor( ), a stream_type field, an elementary_PID field, an ES_info_length field, a descriptor ( ) and/or a CRC_32 field. The table_id field identifies a table type. The table_id field can indicate that the corresponding table section constitutes the PMT. The section_syntax_indicator field indicates the format of the table section following this field. This field indicates that the table section has a short format when set to 0 and the table section has a normal long format when set to 1. The section_length field indicates the length of the table section. The section_length field indicates a length from the end of this field to the end of the corresponding table section and thus the actual length of the table section can be a value corresponding to the value indicated by the section_length field plus 3 bytes. The program_number field identifies each program service or virtual channel present in a transport stream. The version_number field indicates a version number of a private table section. The receiver can find the latest one of table sections stored in a memory using the current_next_indicator field which will be described below. The current_next_indicator field indicates that the currently transmitted table is valid when set to 1 and indicates that the table is not currently valid but will be valid later when set to 0. The section_number field indicates the number of the corresponding section in the corresponding table. The last_section_number field indicates the number of the last section among sections constituting the corresponding table. The PCR_PID field indicates a packet ID corresponding to a packet in which a PCR (Program Clock Reference) for a program service exists. The program_info_length field indicates the length of a descriptor which represents the following program information (program_info). The descriptor( ) refers to a descriptor which represents information about a program corresponding to the corresponding table section. According to an embodiment of the present invention, the descriptor can include a UHD_program_info_descriptor( ) which identifies a UHD service type. The stream_type field indicates the type of each unit stream constituting a program described by the corresponding table. The elementary_PID field indicates a packet ID of each unit stream constituting the program described by the corresponding table. The ES_info_length field indicates the length of a descriptor which represents information (ES_info) about each unit stream following the ES_info_length field. The descriptor( ) refers to a descriptor which represents information about one unit stream from among unit streams constituting the program described by the corresponding table. The CRC_32 field indicates a CRC value used to check whether data included in the corresponding table section has an error. The PMT according to an embodiment of the present invention can be transmitted in band through MPEG-TS and PSI information including the PMT can be transmitted in xml through IP.

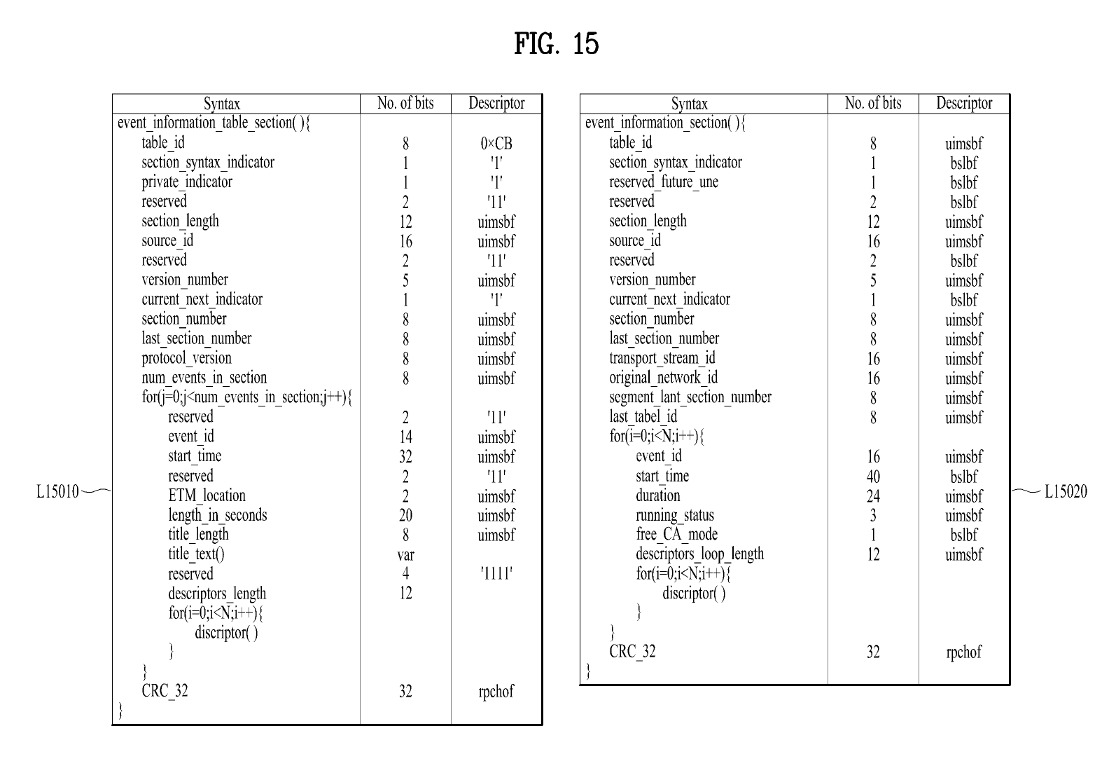

FIG. 15 is a diagram illustrating a case in which the EOTF parameter information according to an embodiment of the present invention is signaled through an EIT (event information table).

The EOTF parameter information according to an embodiment of the present invention can be included in a descriptor of an event level of the EIT in the form of a descriptor (EOTF_parameter_info_descriptor). Furthermore, the UHD_program_info_descriptor described above with reference to the preceding figure can be included in a descriptor of the event level of the EIT.

A receiver according to an embodiment of the present invention can be aware of delivery of the EOTF parameter information by checking that the UHD_service_type of the EIT has a value of 1100 (UHD1 service with EOTF parameter information (=EOTF information metadata), an example of 4K).

A receiver according to another embodiment of the present invention can be aware of delivery of the EOTF parameter information by checking presence or absence of the EOTF_parameter_info_descriptor when the UHD_service_type of the EIT has a value of 0000 (UHD1 service).

A content provider according to an embodiment of the present invention can determine whether an adaptive EOTF can be used in a display of a receiver using the EOTF_parameter_info_descriptor.

The receiver according to an embodiment of the present invention can determine whether EOTF parameter information is used for content which is currently presented or will be presented in the future in advance using the EOTF_parameter_info_descriptor and can perform setting for situations such as reserved recording in advance.

An ATSC_EIT_L15010 according to an embodiment of the present invention includes a table_id field, a section_syntax_indicator field, a section_length field, a service_id field, a version_number field, a current_next_indicator field, a section_number field, a last_section_number field, a transport_stream_id field, an original_network_id field, a segment_last_section_number field, a last_table_id field, an event_id field, a start_time field, a duration field, a running_status field, a free_CA_mode field, a descriptors_loop_length field, a descriptor( ) and/or a CRC_32 field. The table_id field identifies a table type. The table_id field can indicate that the corresponding table section constitutes the EIT. The section_syntax_indicator field indicates the format of the table section following this field. This field indicates that the table section has a short format when set to 0 and the table section has a normal long format when set to 1. The section_length field indicates the length of the table section. The section_length field indicates a length from the end of this field to the end of the corresponding table section. The service_id field identifies each service present in a transport stream. The service_id field may have the same function as the program_number field of the PMT. The version_number field indicates a version number of a private table section. The receiver can find the latest one of table sections stored in a memory using the current_next_indicator field which will be described below. The current_next_indicator field indicates that the currently transmitted table is valid when set to 1 and indicates that the table is not currently valid but will be valid later when set to 0. The section_number field indicates the number of the corresponding section in the corresponding table. The last_section_number field indicates the number of the last section among sections constituting the corresponding table. The transport_stream_id field identifies a transport stream (TS) to be described in the corresponding table. The original_network_id field identifies the initial broadcaster which has transmitted a service or an event described in the corresponding table. The segment_last_section_number field indicates the last section number of a corresponding segment when a sub-table is present. When the sub-table is not segmented, the value indicated by this field can be the same as the value indicated by the last_section_number field. The last_table_id field indicates the last used table_id. The event_id field identifies each event and has a unique value in one service. The start_time field indicates a start time of a corresponding event. The duration field indicates a duration of the corresponding event. For example, in the case of a program which continues for one hour and 45 minutes and 30 seconds, the duration field can indicate 0x014530. The running_status field indicates a status of the corresponding event. The free_CA_mode field indicates that component streams constituting service are not scrambled when set to 0 and indicates that access to one or more streams is controlled by a CA system when set to 1. The CA (Conditional Access) system provides a function of encoding broadcast content and a function of permitting only a contractor to decode and view broadcast content in order to limit users who watch broadcast to contractors. The descriptor_loop_length field indicates a value corresponding to the sum of lengths of descriptors following this field. The descriptor( ) refers to a descriptor described for each event. According to an embodiment of the present invention, the descriptor can include a UHD_program_info_descriptor( ) and/or an EOTF_parameter_info_descriptor which indicate a UHD service type. The CRC_32 field indicates a CRC value used to check whether data included in the corresponding table section has an error.

A DVB SI-EIT L15020 according to an embodiment of the present invention may include fields included in the ATSC_EIT L15010, a service_id field, a transport_stream_id field, an original_network_id field, a segment_last_section_number field, a last_table_id field, a duration field, a running_status field, a free_CA_mode field, a descriptors_loop_length field and/or a descriptor( ). The service_id field indicates the ID of a service related to the corresponding table. The transport_stream_id field indicates the ID of a transport stream in which the corresponding table is transmitted. The original_network_id field indicates the ID of a network through which the corresponding table is transmitted. The segment_last_section_number field indicates the last section number of the corresponding segment. The last_table_id field indicates the ID of the last table. The duration field indicates a duration of a corresponding event. The running_status field indicates a status of the corresponding event. The free_CA_mode field indicates whether the corresponding event has been encoded. The descriptors_loop_length field indicates the length of a descriptor loop of an event level. The descriptor( ) refers to a descriptor described for each event. According to an embodiment of the present invention, the descriptor may include a UHD_program_info_descriptor( ) and/or an EOTF_parameter_info_descriptor which indicate a UHD service type.

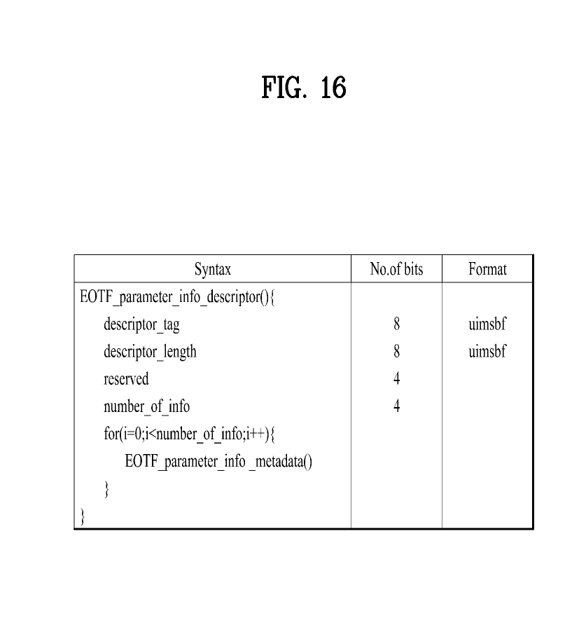

FIG. 16 is a diagram illustrating a configuration of an EOTF_parameter_info_descriptor according to an embodiment of the present invention.

According to an embodiment of the present invention, a plurality of pieces of EOTF parameter information may be present per event. That is, EOTF parameter information is not consistently applied to content and can be changed with time or according to presence or absence of embedded content. Furthermore, various EOTF modes intended by a producer for one piece of content may be supported. Here, according to an embodiment of the present invention, it is necessary to determine whether a display of a receiver can accept such EOTF modes, and information about each EOTF mode can be provided through EOTF parameter information.

The EOTF_parameter_info_descriptor according to an embodiment of the present invention may include a descriptor_tag field, a descriptor_length field, a number_of_info field and/or EOTF_parameter_info_metadata (=EOTF parameter information). The descriptor_tag field indicates that the corresponding descriptor includes EOTF parameter information. The descriptor_length field indicates the length of the descriptor. The number_of_info field indicates the number of pieces of EOTF parameter information provided by a producer. The EOTF_parameter_info_metadata indicates EOTF parameter information which has been described above in detail.

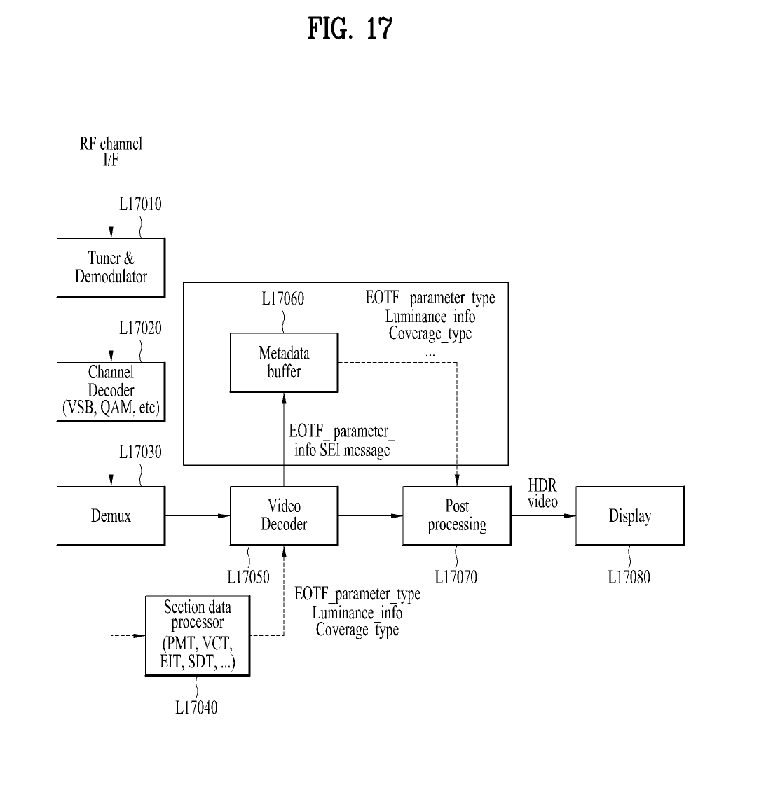

FIG. 17 is a diagram illustrating a structure of a receiver according to an embodiment of the present invention.

The receiver according to an embodiment of the present invention can analyze HDR video information and/or EOTF parameter information and apply the same to HDR video when the information is delivered.

Specifically, the receiver checks whether there are services or media which need to be additionally received in order to constitute the original UHDTV broadcast using the UHD_program_info_descriptor of a received PMT. The receiver according an embodiment of the present invention can recognize that there is supplementary information (EOTF parameter information) delivered through an SEI message when the UHD_service_type in the UHD_program_info_descriptor of the PMT is 1100. A receiver according to another embodiment of the present invention can recognize that there is video related supplementary information (EOTF parameter information) delivered through an SEI message when the UHD_service_type in the UHD_program_info_descriptor of the PMT is 0000 (8K is 0001). When the PMT and/or an EIT include the EOTF parameter information as well as the UHD_program_info_descriptor, the receiver can recognize presence of the EOTF parameter information by receiving the PMT and/or the EIT.

The receiver according to an embodiment of the present invention detects information about an EOTF through the EOTF_parameter_info SEI message, the EOTF_parameter_info_descriptor of the PMT and/or the EOTF_parameter_info_descriptor of the EIT. An SDR receiver presents received video on the basis of legacy EOTF information delivered through VUI. An HDR receiver acquires EOTF parameter information through the EOTF_parameter_info SEI message and/or the EOTF_parameter_info_descriptor. Specifically, the HDR receiver can recognize an EOTF type used when content is encoded or detailed classification with respect to a specific EOTF through the EOTF_parameter_type and apply an EOTF identified by the EOTF_point_x_index, the EOTF_point_y_index, the EOTF_curve_type and the EOTF_curve_coefficient_alpha which are parameters for identifying an EOTF to the content. Furthermore, the HDR receiver can recognize the dynamic range of the EOTF identified by the EOTF_parameter_type through the EOTF_max_luminance and the EOTF_min_luminance.

The receiver according to an embodiment of the present invention can apply the EOTF to a decoded image on the basis of the aforementioned EOTF parameter information to generate a linear dynamic range of the image and then post-process the image through a picture quality enhancement unit (=post-processing unit). The picture quality enhancement unit according to an embodiment of the present invention can recognize the dynamic range of the EOTF through the EOTF_max_luminance and the EOTF_min_luminance and use the same in a post-processing procedure.

The receiver according to an embodiment of the present invention may include a reception unit (tuner) L17010, a demodulator L17010, a channel decoder L17020, a demultiplexer L17030, a signaling information processor (section data processor) L17040, a video decoder L17050, a metadata buffer L17060, a post-processing unit L17070 and/or a display L17080. The reception unit can receive a broadcast signal including EOTF parameter information and UHD content. The demodulator can demodulate the received broadcast signal. The channel decoder can channel-decode the demodulated broadcast signal. The demultiplexer can extract signaling information including EOTF parameter information, video data and audio data from the broadcast signal. The signaling information processor can process section data such as a PMT, a VCT, an EIT and an SDT in the received signaling information. The video decoder can decode a received video stream. Here, the video decoder can decode the video stream using information included in the HDR_info_descriptor (including HDR related information), the EOTF_parameter_info_descriptor and/or the UHD_program_info_descriptor( ) included in the PMT and the EIT extracted by the signaling information processor. The metadata buffer can store an EOTF_parameter_info SEI message delivered through the video stream and/or EOTF parameter information included in the EOTF_parameter_info_descriptor delivered through the system information. The post-processing unit can process luminance of content using the EOTF parameter information delivered from the metadata buffer. The display can display the video processed by the post-processing unit. In this figure, the post-processing unit may be the same as the aforementioned first post-processing unit.

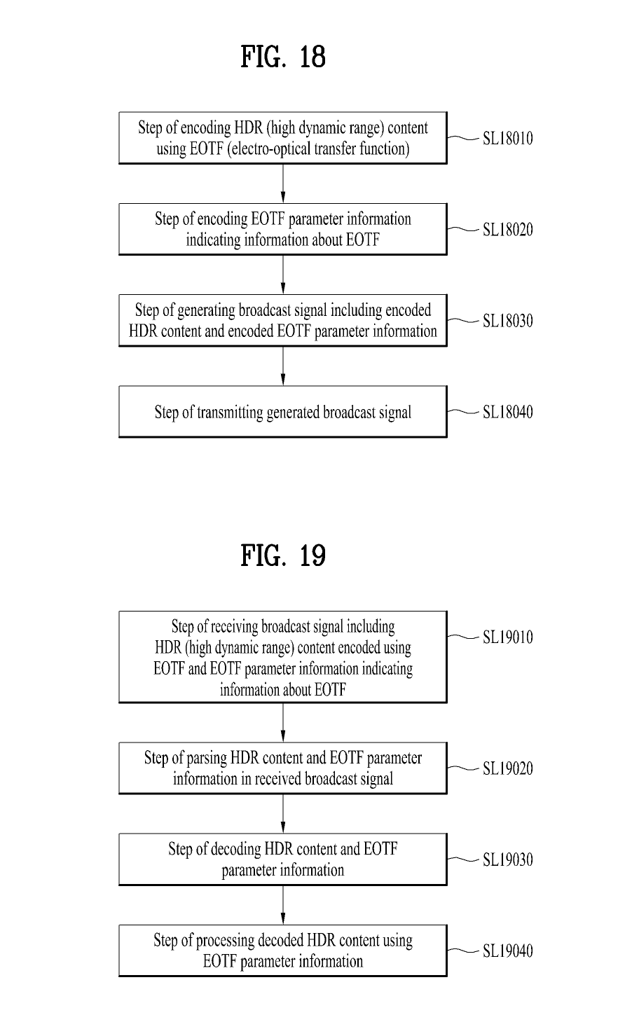

FIG. 18 is a diagram illustrating a broadcast signal transmission method according to an embodiment of the present invention.

The broadcast signal transmission method according to an embodiment of the present invention may include a step SL18010 of encoding HDR (High Dynamic Range) content using an EOTF (Electro-Optical Transfer Function), a step SL18020 of encoding EOTF parameter information indicating information about the EOTF, a step SL18030 of generating a broadcast signal including the encoded HDR content and the encoded EOTF parameter information and/or a step SL18040 of transmitting the generated broadcast signal.

According to another embodiment of the present invention, the EOTF parameter information may include at least one of EOTF type information which indicates the type of the EOTF, EOTF parameter flag information which indicates whether information about a specific parameter used for the EOTF is included in the EOTF parameter information, information on a maximum value of a dynamic range to which the EOTF is applied within the entire dynamic range of the HDR content, and information on a minimum value of the dynamic range to which the EOTF is applied within the entire dynamic range of the HDR content.

According to another embodiment of the present invention, when the EOTF type information indicates that the EOTF has one or more inflection points depending on luminance of content, the EOTF parameter flag information indicates that the information about the specific parameter used for the EOTF is included in the EOTF parameter information, and the EOTF parameter information may include at least one of information about the number of inflection points, which indicates the number of inflection points present within a dynamic range indicated by the maximum value information and the minimum value information, inflection point position information, curve type information which indicates a type of a curve applied to a dynamic range defined by inflection points, and parameter information applied to a curve indicated by the curve type information.

According to another embodiment of the present invention, at least one of the inflection point position information, the maximum value information and the minimum value information may indicate a relative luminance value or an absolute luminance value with respect to the HDR content.

According to another embodiment of the present invention, the EOTF is changed with time, and the EOTF parameter information may include at least one of information about a time for which the EOTF is applied, information indicating whether the EOTF is changed, and parameter information about an EOTF which will be changed from the EOTF.

According to another embodiment of the present invention, the broadcast signal may include system information for processing the HDR content, the system information may include a UHD program information descriptor including UHD service type information which identifies a type of a UHD (Ultra High Definition) service including the HDR content, and the UHD service type information may indicate that the UHD service including the HDR content is based on the EOTF parameter information.

According to another embodiment of the present invention, the EOTF parameter information may be included in at least one of the system information and an SEI (supplemental enhancement information) message of a video stream including the encoded HDR content.

FIG. 19 is a diagram illustrating a broadcast signal reception method according to an embodiment of the present invention.

The broadcast signal reception method according to an embodiment of the present invention may include a step S19010 of receiving a broadcast signal including HDR content encoded using an EOTF, and EOTF parameter information indicating information about the EOTF, a step S19020 of parsing the HDR content and the EOTF parameter information in the received broadcast signal, a step SL19030 of decoding the HDR content and the EOTF parameter information and/or a step SL19040 of processing the decoded HDR content using the EOTF parameter information.

According to another embodiment of the present invention, the EOTF parameter information may include at least one of EOTF type information which indicates the type of the EOTF, EOTF parameter flag information which indicates whether information about a specific parameter used for the EOTF is included in the EOTF parameter information, information on a maximum value of a dynamic range to which the EOTF is applied within the entire dynamic range of the HDR content, and information on a minimum value of the dynamic range to which the EOTF is applied within the entire dynamic range of the HDR content.

According to another embodiment of the present invention, when the EOTF type information indicates that the EOTF has one or more inflection points depending on luminance of content, the EOTF parameter flag information indicates that the information about the specific parameter used for the EOTF is included in the EOTF parameter information, and the EOTF parameter information may include at least one of information about the number of inflection points, which indicates the number of inflection points present within a dynamic range indicated by the maximum value information and the minimum value information, inflection point position information, curve type information which indicates a type of a curve applied to a dynamic range defined by inflection points, and parameter information applied to a curve indicated by the curve type information.

According to another embodiment of the present invention, at least one of the inflection point position information, the maximum value information and the minimum value information may indicate a relative luminance value or an absolute luminance value with respect to the HDR content.

According to another embodiment of the present invention, the EOTF is changed with time, and the EOTF parameter information may include at least one of information about a time for which the EOTF is applied, information indicating whether the EOTF is changed, and parameter information about an EOTF which will be changed from the EOTF.

According to another embodiment of the present invention, the broadcast signal may include system information for processing the HDR content, the system information may include a UHD program information descriptor including UHD service type information which identifies a type of a UHD (Ultra High Definition) service including the HDR content, and the UHD service type information may indicate that the UHD service including the HDR content is based on the EOTF parameter information.

According to another embodiment of the present invention, the EOTF parameter information may be included in at least one of the system information and an SEI (supplemental enhancement information) message of a video stream including the encoded HDR content.

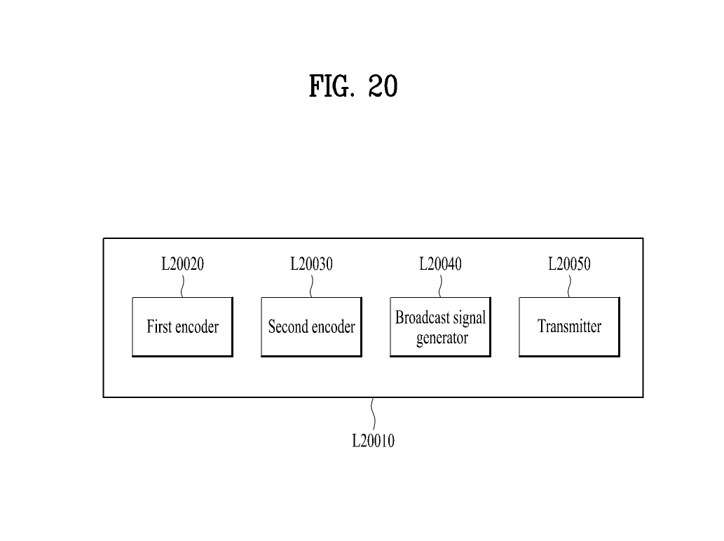

FIG. 20 is a diagram illustrating a configuration of a broadcast signal transmission apparatus according to an embodiment of the present invention.

The broadcast signal transmission apparatus L20010 according to an embodiment of the present invention may include a first encoder L20020 for encoding HDR content using an EOTF, a second encoder L20030 for encoding EOTF parameter information indicating information about the EOTF, a broadcast signal generator L20040 for generating a broadcast signal including the encoded HDR content and the encoded EOTF parameter information and/or a transmitter L20050 for transmitting the generated broadcast signal.

Modules, units or blocks according to embodiments of the present invention may be processors/hardware executing consecutive procedures stored in a memory (or storage unit). The steps or methods described in the above embodiments may be performed by hardware/processors. In addition, the methods proposed by the present invention may be executed as code. This code can be written in a processor-readable storage medium and thus read by a processor provided by the apparatus according to embodiments of the present invention.

While the embodiments have been described with reference to respective drawings for convenience, embodiments may be combined to implement a new embodiment. In addition, designing a computer-readable recording medium storing programs for implementing the aforementioned embodiments is within the scope of the present invention.

The apparatus and method according to the present invention are not limited to the configurations and methods of the above-described embodiments and all or some of the embodiments may be selectively combined to obtain various modifications.

The image processing methods according to the present invention may be implemented as processor-readable code stored in a processor-readable recording medium included in a network device. The processor-readable recording medium includes all kinds of recording media storing data readable by a processor. Examples of the processor-readable recording medium include a ROM, a RAM, a CD-ROM, a magnetic tape, a floppy disk, an optical data storage device and the like, and implementation as carrier waves such as transmission over the Internet. In addition, the processor-readable recording medium may be distributed to computer systems connected through a network, stored and executed as code readable in a distributed manner.

Although the preferred embodiments of the present invention have been disclosed for illustrative purposes, those skilled in the art will appreciate that various modifications, additions and substitutions are possible, without departing from the scope and spirit of the invention as disclosed in the accompanying claims. Such modifications should not be individually understood from the technical spirit or prospect of the present invention.

Both apparatus and method inventions are mentioned in this specification and descriptions of both the apparatus and method inventions may be complementarily applied to each other.

It will be apparent to those skilled in the art that various modifications and variations can be made in the present invention without departing from the spirit or scope of the inventions. Thus, it is intended that the present invention cover the modifications and variations of this invention provided they come within the scope of the appended claims and their equivalents.

Both apparatus and method inventions are mentioned in this specification and descriptions of both the apparatus and method inventions may be complementarily applied to each other.

### MODE FOR INVENTION

Various embodiments have been described in the best mode for carrying out the invention.

### INDUSTRIAL APPLICABILITY

The present invention is applicable to fields in which broadcast signals are provided.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

1. A method of transmitting a broadcast signal, comprising:
encoding a HDR (High Dynamic Range) content using an EOTF (Electro-Optical Transfer Function);
encoding EOTF parameter information indicating information about the EOTF,
wherein the EOTF parameter information includes EOTF parameter flag information indicating whether information about a specific parameter used for the EOTF is included in the EOTF parameter information;
generating a broadcast signal including the encoded HDR content and the encoded EOTF parameter information; and
transmitting the generated broadcast signal.

2. The method according to claim 1, wherein the EOTF parameter information includes at least one of EOTF type information which indicates a type of the EOTF, information on a maximum value of a dynamic range to which the EOTF is applied within the entire dynamic range of the HDR content, and information on a minimum value of the dynamic range to which the EOTF is applied within the entire dynamic range of the HDR content.

3. The method according to claim 2, wherein, when the EOTF type information indicates that the EOTF has one or more inflection points depending on luminance of content, the EOTF parameter flag information indicates that the information about the specific parameter used for the EOTF is included in the EOTF parameter information, and
wherein the EOTF parameter information includes at least one of information about the number of inflection points, which indicates the number of inflection points present within a dynamic range indicated by the maximum value information and the minimum value information, inflection point position information, curve type information which indicates a type of a curve applied to a dynamic range defined by inflection points, and parameter information applied to a curve indicated by the curve type information.

4. The method according to claim 3, wherein at least one of the inflection point position information, the maximum value information and the minimum value information indicates a relative luminance value or an absolute luminance value with respect to the HDR content.

5. The method according to claim 1, wherein the EOTF is changed with time, and the EOTF parameter information includes at least one of information about a time for which the EOTF is applied, information indicating whether the EOTF is changed, and parameter information about an EOTF which will be changed from the EOTF.

6. The method according to claim 1, wherein the broadcast signal includes system information for processing the HDR content,
wherein the system information includes a UHD program information descriptor including UHD service type information which identifies a type of a UHD (Ultra High Definition) service including the HDR content,
wherein the UHD service type information indicates that the UHD service including the HDR content is based on the EOTF parameter information.

7. The method according to claim 6, wherein the EOTF parameter information is included in at least one of the system information and an SEI (supplemental enhancement information) message of a video stream including the encoded HDR content.

8. A method of receiving a broadcast signal, comprising:
receiving a broadcast signal including a HDR content encoded using an EOTF, and EOTF parameter information indicating information about the EOTF,
wherein the EOTF parameter information includes EOTF parameter flag information indicating whether information about a specific parameter used for the EOTF is included in the EOTF parameter information;
parsing the HDR content and the EOTF parameter information in the received broadcast signal
decoding the HDR content and the EOTF parameter information; and
processing the decoded HDR content using the EOTF parameter information.

9. The method according to claim 8, wherein the EOTF parameter information includes at least one of EOTF type information which indicates a type of the EOTF, information on a maximum value of a dynamic range to which the EOTF is applied within the entire dynamic range of the HDR content, and information on a minimum value of the dynamic range to which the EOTF is applied within the entire dynamic range of the HDR content.

10. The method according to claim 9, wherein, when the EOTF type information indicates that the EOTF has one or more inflection points depending on luminance of content, the EOTF parameter flag information indicates that the information about the specific parameter used for the EOTF is included in the EOTF parameter information, and
wherein the EOTF parameter information includes at least one of information about the number of inflection points, which indicates the number of inflection points present within a dynamic range indicated by the maximum value information and the minimum value information, inflection point position information, curve type information which indicates a type of a curve applied to a dynamic range defined by inflection points, and parameter information applied to a curve indicated by the curve type information.

11. The method according to claim 10, wherein at least one of the inflection point position information, the maximum value information and the minimum value information indicates a relative luminance value or an absolute luminance value with respect to the HDR content.

12. The method according to claim 8, wherein the EOTF is changed with time, and the EOTF parameter information includes at least one of information about a time for which the EOTF is applied, information indicating whether the EOTF is changed, and parameter information about an EOTF which will be changed from the EOTF.

13. The method according to claim 8, wherein the broadcast signal includes system information for processing the HDR content,
wherein the system information includes a UHD program information descriptor including UHD service type information which identifies a type of a UHD (Ultra High Definition) service including the HDR content,
wherein the UHD service type information indicates that the UHD service including the HDR content is based on the EOTF parameter information.

14. The method according to claim 13, wherein the EOTF parameter information is included in at least one of the system information and an SEI (supplemental enhancement information) message of a video stream including the encoded HDR content.

15. An apparatus for transmitting a broadcast signal, comprising:
a first encoder for encoding a HDR (High Dynamic Range) content using an EOTF (Electro-Optical Transfer Function);
a second encoder for encoding EOTF parameter information indicating information about the EOTF,
wherein the EOTF parameter information includes EOTF parameter flag information indicating whether information about a specific parameter used for the EOTF is included in the EOTF parameter information;
a broadcast signal generator for generating a broadcast signal including the encoded HDR content and the encoded EITF parameter information; and
a transmitter for transmitting the generated broadcast signal.
